(19) United States
(12) Patent Application Publication
(10) Pub. No.: US 2013/0106671 A1
(43) Pub. Date: May 2, 2013

(54) MULTI-FUNCTION FEED NETWORK AND ANTENNA IN COMMUNICATION SYSTEM

(71) Applicant: Electronics and Telecommunications Research In, Daejeon (KR)

(72) Inventors: Soon-Young EOM, Daejeon (KR); Joung-Myoun KIM, Daejeon (KR); Jeong-Ho JU, Daejeon (KR); Dong-Uk SIM, Chungbuk (KR); Jae-Ick CHOI, Daejeon (KR)

(73) Assignee: ELECTRONICS AND TELECOMMUNICATIONS RESEARCH, Daejeon (KR)

(21) Appl. No.: 13/661,251

(22) Filed: Oct. 26, 2012

(30) Foreign Application Priority Data
Oct. 27, 2011 (KR) 10-2011-0110681
Sep. 25, 2012 (KR) 10-2012-0106353

(51) Int. Cl. H01Q 21/00; H01Q 3/24; H01P 5/12

(52) U.S. Cl. 343/853; 333/136; 343/876; 343/893

(57) ABSTRACT

Disclosed are a multi-function feed network capable of controlling a radiation pattern diversity and an orthogonal polarization diversity of an antenna transmitting and receiving a signal in a communication system and an antenna including the multi-function feed network. The multi-function feed network includes a plurality of output nodes; boundary transmission lines connecting between the output nodes; cross transmission lines configured to be connected with a part of the boundary transmission lines and crossed in an area configured of the boundary transmission lines; input terminals configured to be connected with one of nodes formed by the boundary transmission lines and nodes formed by the crossing transmission lines and input signals; and output terminals configured to be connected with each of the output nodes and divide and output the input signals.

### CROSS-REFERENCES TO RELATED APPLICATIONS

The present application claims priority of Korean Patent Application Nos. 10-2011-0110681 and 10-2012-0106353, filed on Oct. 27, 2011, and Sep. 25, 2012, respectively, which are incorporated herein by reference in their entirety.

### BACKGROUND OF THE INVENTION

1. Field of the Invention

Exemplary embodiments of the present invention relate to a communication system, and more particularly, to a multi-function feed network capable of controlling a radiation pattern diversity and an orthogonal polarization diversity of an antenna transmitting and receiving a signal in a communication system and an antenna including the multi-function feed network.

2. Description of Related Art

In a communication system, an antenna can wirelessly transmit and receive data through a predetermined frequency. In a communication system, an antenna, which is an important element for transmitting and receiving a signal, is located at an end of a transceiver to transmit and receive a signal. Many researches and developments into an antenna structure for effectively transmitting and receiving a signal have been conducted.

Various types of antennas are present, but an example of a generally used high frequency antenna may include a dipole antenna, a monopole antenna, a patch antenna, a horn antenna, a parabolic antenna, a helical antenna, a slot antenna, and the like. These antennas have been applied according to a communication distance and a service area.

Meanwhile, an example of essential resources used in a communication system may include frequency, polarization, space, and direction. Today, wireless communication services have been evolved to a type of transmitting high-speed and large-capacity data and various types of wireless communication services have been increased. Therefore, a frequency resource among resources of the communication system has been depleted.

A demand for a multiple input multiple output (hereinafter, referred to as ‘MIMO’) communication technology using a MIMO antenna due to a depletion of the frequency resource has been increased. The MIMO communication technology performs independent multiple channel transmission through the MIMO antenna to increase communication capacity. However, a terminal, a repeater, a base station, and the like, which use the currently used MIMO communication technology, use defined antenna beam patterns or fixed polarization. The MIMO antenna structure using the defined antenna beam patterns or the fixed polarization is not appropriate for the high-speed and large-capacity data transmission.

Therefore, a need exists for an MIMO antenna structure flexibly applying or using resources such as polarization, space, and direction (for example, antenna beam patterns), and the like, that are resources other than frequency resources of a communication system.

### SUMMARY OF THE INVENTION

An embodiment of the present invention is directed to a multi-function feed network capable of providing antenna beam pattern diversity and orthogonal polarization diversity in a communication system and an antenna including the multi-function feed network.

The foregoing and other objects, features, aspects and advantages of the present invention will be understood and become more apparent from the following detailed description of the present invention. Also, it can be easily understood that the objects and advantages of the present invention can be realized by the units and combinations thereof recited in the claims.

An antenna including a multi-function feed network in a communication system, includes: array antenna elements configured to transmit and receive signals; and a feed network configured to divide and output a plurality of input signals to the array antenna elements, wherein the feed network includes: output nodes; boundary transmission lines connecting between the output nodes; cross transmission lines configured to be connected with a part of the boundary transmission lines and crossed in an area configured of the boundary transmission lines; input terminals configured to be connected with one of nodes formed by the boundary transmission lines and nodes formed by the cross transmission lines and input signals; and output terminals configured to be connected with each of the output nodes and output the input signals.

A multi-function feed network in a communication system, includes: a plurality of output nodes; boundary transmission lines connecting between the output nodes; cross transmission lines configured to be connected with a part of the boundary transmission lines and crossed in an area configured of the boundary transmission lines; input terminals configured to be connected with one of nodes formed by the boundary transmission lines and nodes formed by the crossing transmission lines and input signals; and output terminals configured to be connected with each of the output nodes and divide and output the input signals.

### BRIEF DESCRIPTION OF THE DRAWINGS

FIG. 1 is a diagram illustrating a first feed network in a communication system in accordance with an embodiment of the present invention.

FIG. 2 is a diagram illustrating a signal output operation using the first feed network in the communication system in accordance with the embodiment of the present invention.

FIG. 3 is a diagram illustrating a second feed network in the communication system in accordance with the embodiment of the present invention.

FIG. 4 is a diagram illustrating a signal output operation using the second feed network in the communication system in accordance with the embodiment of the present invention.

FIG. 5 is a diagram illustrating a third feed network in the communication system in accordance with the embodiment of the present invention.

FIG. 6 is a diagram illustrating a fourth feed network in the communication system in accordance with the embodiment of the present invention.

FIG. 7 is a diagram illustrating a fifth feed network for miniaturization in the communication system in accordance with the embodiment of the present invention.

FIG. 8 is a diagram illustrating a first antenna with array antenna elements connected in a ring type in the communication system in accordance with the embodiment of the present invention and using the first feed network.

FIG. 9 is a diagram illustrating a second antenna with the array antenna elements connected in a cross type in the communication system in accordance with the embodiment of the present invention and using the first feed network.

FIG. 10 is a diagram illustrating a third antenna with the array antenna elements connected in a ring type in the communication system in accordance with the embodiment of the present invention and using the second feed network.

FIG. 11 is a diagram illustrating a fourth antenna with the array antenna elements connected in a ring type in the communication system in accordance with the embodiment of the present invention and using a changed second feed network.

FIG. 12 is a diagram illustrating a fifth antenna with the array antenna elements connected in a cross type in the communication system in accordance with the embodiment of the present invention and using the second feed network.

FIG. 13 is a diagram illustrating a sixth antenna with the array antenna elements connected in a cross type in the communication system in accordance with the embodiment of the present invention and using the changed second feed network.

FIG. 14 is a diagram illustrating a seventh antenna including 90° phase shifters in the communication system in accordance with the embodiment of the present invention.

FIG. 15 is a diagram illustrating an eighth antenna including 0° phase shifters and 90° phase shifters in the communication system in accordance with the embodiment of the present invention.

FIG. 16 is a diagram illustrating a ninth antenna including 180° phase shifters in the communication system in accordance with the embodiment of the present invention.

FIG. 17 is a diagram illustrating a tenth antenna including 0° phase shifters and 180° phase shifters in the communication system in accordance with the embodiment of the present invention.

FIG. 18 is a diagram illustrating an eleventh antenna including 0° phase shifters and 180° phase shifters in the communication system in accordance with the embodiment of the present invention.

FIG. 19 is a diagram illustrating a twelfth antenna including 90°/180°, phase shifters in the communication system in accordance with the embodiment of the present invention.

FIG. 20 is a conceptual diagram of a thirteenth antenna with a 4×4 MIMO antenna structure in the communication system in accordance with the embodiment of the present invention.

FIG. 21 is a diagram illustrating a thirteenth antenna structure of FIG. 20.

FIG. 22 is a conceptual diagram of a fourteenth antenna with the 4×4 MIMO antenna structure in the communication system in accordance with the embodiment of the present invention.

FIG. 23 is a diagram illustrating a fourteenth antenna structure of FIG. 22.

FIG. 24 is a conceptual diagram of a fifteenth antenna with the 4×4 MIMO antenna structure of the reduced size in accordance with the embodiment of the present invention.

FIG. 25 is a diagram illustrating the fifteenth antenna structure illustrated in FIG. 24.

FIG. 26 is a diagram illustrating a sixteenth antenna with the extended number of channels using the fifteenth antennas in the communication system in accordance with the embodiment of the present invention.

### DESCRIPTION OF SPECIFIC EMBODIMENTS

Hereinafter, embodiments of the present invention will be described in detail with reference to the accompanying drawings. It is to be noted that only components required to understand an operation in accordance with the present invention is described below and the description of other components will be omitted not to unnecessarily obscure the subject matters of the present invention.

An embodiment of the present invention relates to a multi-function feed network capable of reconfiguring antenna characteristics in a communication system and an antennal including the multi-function feed network. In this case, the antenna characteristics include, for example, polarization and radiation patterns. The multi-function feed network and an antenna including the multi-function feed network in accordance with the embodiment of the present invention may be used for various terrestrial or satellite communication systems for wirelessly transmitting and receiving data.

The antenna including the multi-function feed network in accordance with the embodiment of the present invention is described based on a multiple input multiple output (hereinafter, referred to as ‘MIMO’) antenna, but may be extendedly applied to an antenna structure that requires multiple input multiple output.

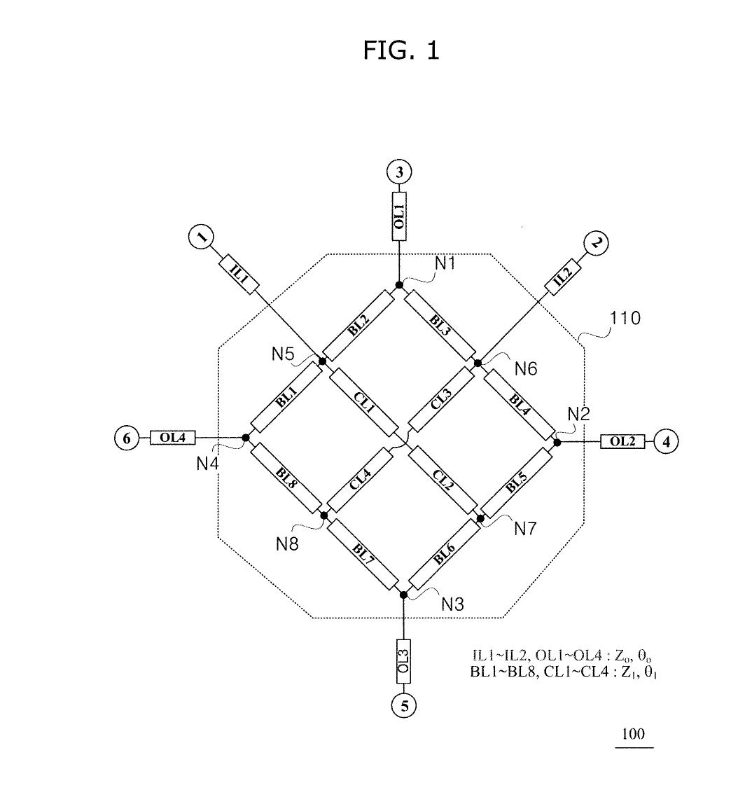

FIG. 1 is a diagram illustrating a first feed network in a communication system in accordance with an embodiment of the present invention.

Referring to FIG. 1, a first feed network 100 includes a first internal feed network 110. Further, the first feed network 100 includes transmission lines IL1, IL2, OL1, OL2, OL3, and OL4 connected with the first internal feed network 110 and terminals 1, 2, 3, 4, 5, and 6 connected with each of the transmission lines IL1, IL2, OL1, OL2, OL3, and OL4.

A first input terminal 1 and a second input terminal 2 among the terminals 1, 2, 3, 5, 5, and 6 are terminals receiving a signal and the first output terminal 3, the second output terminal 4, the third output terminal 5, and the fourth output terminal 6 are terminals outputting a signal. For example, the output terminals 3, 4, 5, and 6 outputting the signal may have a quadrangular shape. In this configuration, a shape of the output terminals 3, 4, 5, and 6 is described by way of example, but may have other shapes other than the quadrangular shape.

Therefore, the first input transmission line IL1 is connected with the first input terminal 1 and the second input transmission line IL2 is connected with the second input terminal 2. The first output transmission line OL1 is connected with the first output terminal 3, the second output transmission line OL2 is connected with the second output terminal 2, the third output transmission line OL3 is connected with the third output terminal 5, and the fourth output transmission line OL4 is connected with the fourth output terminal 6.

In this configuration, describing electrical variables of the input transmission lines IL1 and IL2 and the output transmission lines OL1, OL2, OL3, and OL4, it may be assumed that input or output characteristic impedance is Z0 (for example, 50Ω) and an electrical length is θ0 (any value).

The first internal feed network 110 includes nodes N1, N2, N3, N4, N5, N6, N7, and N8 and transmission lines BL1, BL2, BL3, BL4, BL5, BL6, BL7, BL8, CL1, CL2, CL3, and CL4.

The first internal feed network 110 includes the first node N1 connected through the first output transmission line OL1, the second node N2 connected through the second output transmission line OL2, the third node N3 connected through the third output transmission line OL3, and the fourth node N4 connected through the fourth output transmission line OL4. The first internal feed network 110 includes the fifth node N5 connected through the first input transmission line IL1 and the sixth node N6 connected through the second input transmission line IL2. In addition, the first internal feed network 110 includes the seventh node N7 located between the second node N2 and the third node N3 and the eighth node N8 located between the third node N3 and the first node N1.

Next, the first boundary transmission line BL1 and the second boundary transmission line BL2 connect the fourth node N4 with the first node N1 and the fifth node N5 is located between the first boundary transmission line BL1 and the second boundary transmission line BL2. The third boundary transmission line BL3 and the fourth boundary transmission line BL4 connect the first node N1 with the second node N2 and the sixth node N6 is located between the third boundary transmission line BL3 and the fourth boundary transmission line BL4. The fifth boundary transmission line BL5 and the sixth boundary transmission line BL6 connect the second node N2 with the third node N3 and the seventh node N7 is located between the fifth boundary transmission line BL5 and the sixth boundary transmission line BL6. The seventh boundary transmission line BL7 and the eighth boundary transmission line BL8 connect the third node N3 with the fourth node N4 and the eighth node N8 is located between the seventh boundary transmission line BL7 and the eighth boundary transmission line BL8.

Finally, the first cross transmission line CL1 and the second cross transmission line CL2 connect the fifth node N5 with the seventh node N7. The third cross transmission line CL3 and the fourth cross transmission line CL4 connect the sixth node N6 with the eighth node N8. Here, the cross transmission lines CL1 and CL2 and the cross transmission lines CL3 and CL4 are connected with each other by RF crossover.

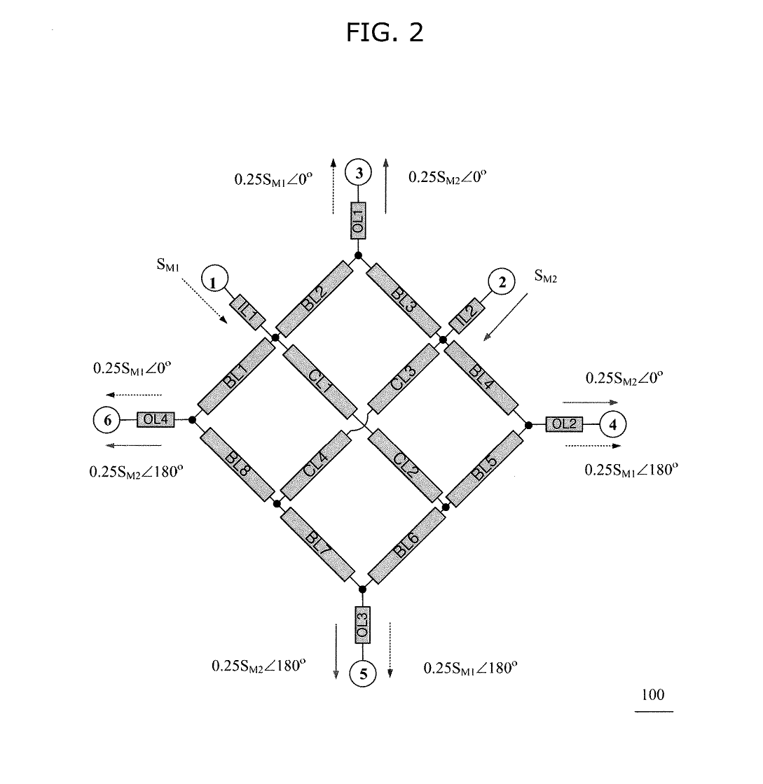

Here, describing the electrical variable of the boundary transmission lines BL1, BL2, BL3, BL4, BL5, BL6, BL7, and BL8 and the cross transmission lines CL1, CL2, CL3, and CL4, it may be assumed that the characteristic impedance is Z1 (Z1=2 Z0, for example, if Z0 is 50Ω, Z1 is 100Ω) and the electrical length is θ1=90°. Next, the signal output operation through the first feed network 100 will be described with reference to FIG. 2.

FIG. 2 is a diagram illustrating a signal output operation using the first feed network in the communication system in accordance with the embodiment of the present invention.

Referring to FIG. 2, a first signal S_{M1} is input through the first input terminal 1 and a second signal S_{M2} is input through the second input terminal 2, in the first feed network 100.

Here, each of the first signal S_{M1} and the second signal S_{M2} is output at the same power division ratio (0.25) through four output terminals 3, 4, 5, and 6.

In this case, a relative phase difference at the output terminals 3, 4, 5, and 6 may be determined according to the locations of each of the input terminals 1 and 2. For example, signals with a reference phase of 0° are output through the first output terminal 3 and the fourth output terminal 6 by the first signal S_{M1} input through the first input terminal 1 and signals with a phase delay of 180° are output through the second output terminal 4 and the third output terminal 5. Further, signals with a reference phase of 0° are output through the first output terminal 3 and the second output terminal 4 by the second signal S_{M2} input through the second input terminal 2 and signals with a phase delay of 180° are output through the third output terminal 5 and the fourth output terminal 6.

Here, input matching characteristics of each of the input terminals 1 and 2 and isolation characteristics between the input terminals 1 and 2 are very excellent in a wide band (about a bandwidth of about 10 to 20%). However, each output matching characteristic among the output terminals 3, 4, 5, and 6 is −6 dB and the isolation characteristic between the output terminals are partially shown. That is, the isolation characteristic of −6 dB is shown between the output terminals located in a diagonal direction that faces each other and the high isolation characteristic is shown among the remaining terminals.

In this way, in the exemplary embodiment of the present invention, the antenna with a planar six-port feeding structure like the first feed network 100 may be applied to an array antenna configured of four array elements. As described above, the first feed network 100 to which the array antenna is applied may be used to variously reconfigure the polarization and the radiation patterns.

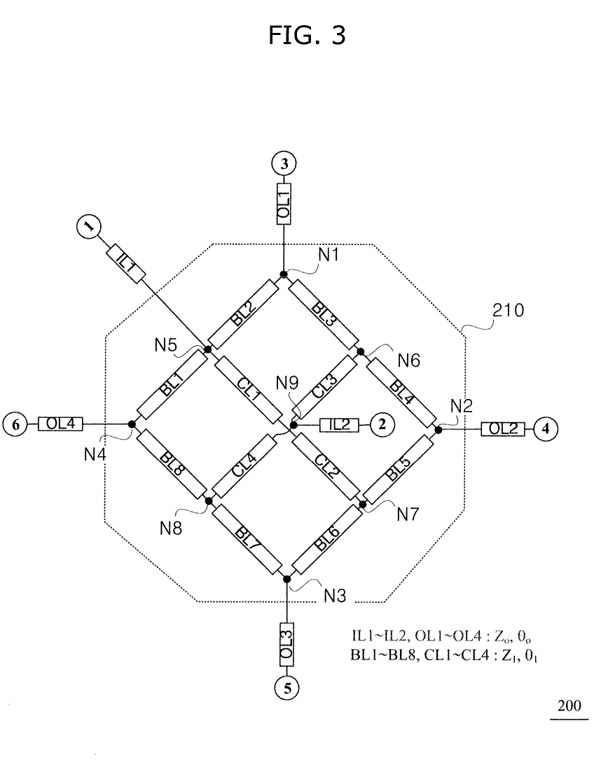

FIG. 3 is a diagram illustrating a second feed network in the communication system in accordance with an embodiment of the present invention.

Referring to FIG. 3, a second feed network 200 includes a second internal feed network 210. Further, the second feed network 200 includes the transmission lines IL1, IL2, OL1, OL2, OL3, and OL4 connected with the second internal feed network 210 and the terminals 1, 2, 3, 4, 5, and 6 connected with each of the transmission lines IL', IL2, OL1, OL2, OL3, and OL4.

The second feed network 200 is different from the first feed network 100 in terms of the structure in which the second input terminal 2 is connected with the second internal feed network 210.

The second internal feed network 210 has a structure similar to the first internal feed network 110. However, the second internal feed network 210 additionally includes the ninth node N9 located between the third cross transmission line CL3 and the fourth cross transmission line CL4. Therefore, the ninth node N9 may be located in the vicinity of a center of an area configured of the transmission lines BL1 to BL10 that are formed through the output terminals 3, 4, 5, and 6.

In this case, the second input terminal 2 is connected with the ninth node N9 through the second input transmission line IL2. Therefore, the structure of the second feed network 200 is similar to the structure of the first feed network 100, except for the structure in which the second input terminal 2 is connected with the ninth node N9 located in the vicinity of the center of the second internal feed network 210. Therefore, a description of the detailed structure of the second feed network 200 refers to the description of the first feed network 100.

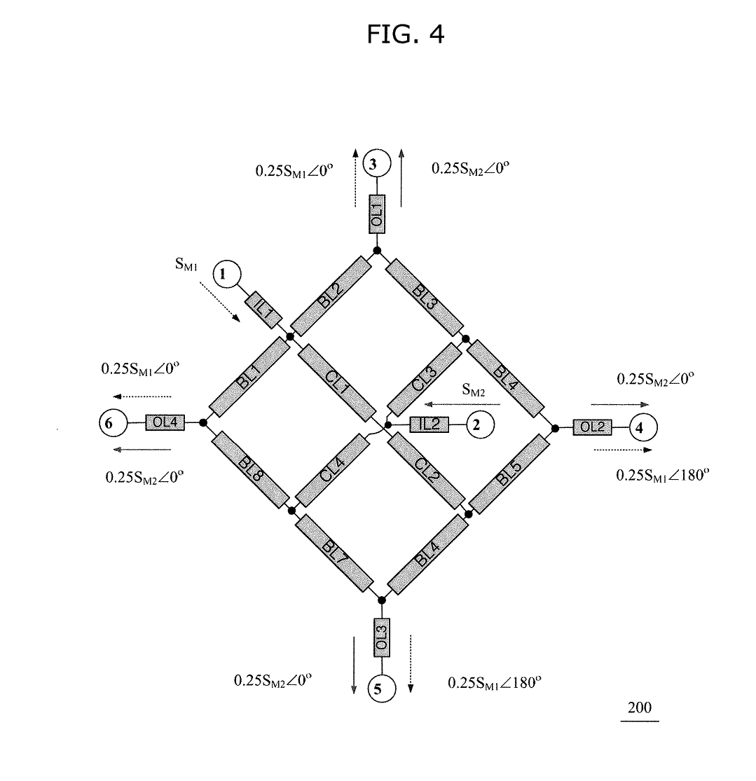

FIG. 4 is a diagram illustrating the signal output operation using the second feed network in the communication system in accordance with the embodiment of the present invention.

Referring to FIG. 4, a first signal S_{M1} is input through the first input terminal 2 and a second signal S_{M2} is input through the second input terminal 2, in the first feed network 200.

Here, each of the first signal S_{M1} and the second signal S_{M2} is output at the same power division ratio (0.25) through four output terminals 3, 4, 5, and 6.

In this case, the relative phase difference at the output terminals 3, 4, 5, and 6 may be determined according to the locations of each of the input terminals 1 and 2. For example, the signals with a reference phase of 0° are output through the first output terminal 1 and the fourth output terminal 6 by the first signal S_{M1} input through the first input terminal 1 and the signals with a phase delay of 180° are output through the second output terminal 4 and the third output terminal 5. Further, the signals with the reference phase (the same phase) of 0° are output from all of the first output terminal 3, the second output terminal 4, the third output terminal 5, and the fourth output terminal 6 by the second signal S_{M2} input through the second input terminal 2.

Here, the input matching characteristics of each of the input terminals 1 and 2 and the isolation characteristics between the input terminals 1 and 2 are very excellent in a wide band (about a bandwidth of about 10 to 20%). However, each output matching characteristic among the output terminals 3, 4, 5, and 6 is very excellent and the isolation characteristic between the output terminals are partially shown. That is, the excellent isolation characteristic is shown among the output terminals with the output of the same phase difference (0° or 180°) and the isolation characteristic of −6 dB is shown between neighbor output terminals that have an output of a phase difference of 180° to the output terminals located in a diagonal direction.

Here, the locations of the first input terminal 1 and the second input terminal 2 may be opposite to each other. Therefore, the second input terminal 2 may be located (connected to the sixth node N6) at an edge or the outside of the second internal feed network 210 and the first input terminal 1 may also be connected to a node (not illustrated) that is located between the first cross transmission line 1 and the second cross transmission line located in the vicinity of the center of the second internal feed network 210.

In this case, the signals with the reference phase (the same phases) of 0° are output from all of the first output terminal 3, the second output terminal 4, the third output terminal 5, and the fourth output terminal 6 by the first signal S_{M1} input through the first input terminal 1. Further, the signals with a reference phase of 0° are output through the first output terminal 3 and the second output terminal 4 by the second signal Sₘ₂ input through the second input terminal 2 and the signals with a phase delay of 180° are output through the third output terminal 5 and the fourth output terminal 6.

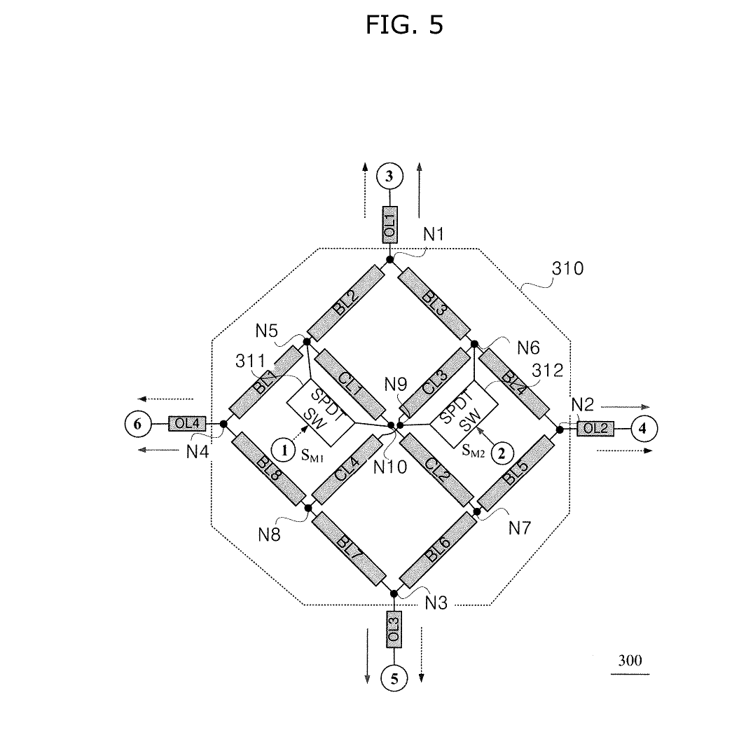

FIG. 5 is a diagram illustrating a third feed network in the communication system in accordance with the embodiment of the present invention.

Referring to FIG. 5, a third feed network 300 includes a third internal feed network 310. The third feed network 300 includes a first switch 311 and a second switch 312 and includes a first input terminal 1 connected with the first switch 312 and a second input terminal 2 connected with the second switch 312. Further, the third feed network 300 includes four transmission lines OL1, OL2, OL3, and OL4 connected with the third internal feed network 310 and the output terminals 3, 4, 5, and 6 connected with each of the transmission lines OL1, OL2, OL3, and OL4.

The third feed network 300 is different from the first feed network 100 in terms of the structure in which the first input terminal 1 and the second input terminal 2 are connected with the third internal feed network 310.

The third internal feed network 300 has a structure similar to the first internal feed network 100 of the first feed network 100. However, the third internal feed network 300 additionally includes a tenth node N10 located between the first cross transmission line CL1 and the second cross transmission line CL2 and the ninth node N9 located between the third cross transmission line CL3 and the fourth cross transmission line CL4. Therefore, the ninth node N9 and the tenth node N10 may be located in the vicinity of the center of the area configured of the transmission lines BL1 to BL8 that are formed through the output terminals 3, 4, 5, and 6.

In this case, the first input terminal 1 is connected with the first switch 311 that is connected with the fifth node N5 and the tenth node N10. In this case, the first switch 311 may connect the first input terminal 1 with one of the fifth node N5 that is located at the edge of the area and the tenth node N10 that is located at the center of the area.

The second input terminal 2 is connected with the second switch 312 that is connected with the sixth node N6 and the ninth node N9. In this case, the second switch 312 may connect the second input terminal 2 with one of the sixth node N6 that is located at the edge of the area and the ninth node N9 that is located at the center of the area.

For example, the first switch 311 and the second switch 312 may be a single pole double throw (SPDT) switch.

Meanwhile, the first switch 311 and the second switch 312 cannot simultaneously select the ninth node N9 and the tenth node N10 that are located at a central point. The reason is that the input matching characteristic and the isolation characteristic between the input terminals are largely deteriorated.

The following Table 1 shows the output characteristics according to the switching operation of the switches 311 and 312 connected with the input terminals 1 and 2.

TABLE 1

| | | | Output | Output | Output | Output |
|---|---|---|---|---|---|---|
| | Input | Slect | Terminal | Terminal | Terminal | Terminal |
| Case | Terminal | Node | (3) | (4) | (5) | (6) |
| 1 | 1 | N5 | 0.25S_{M1} | 0.25S_{M1} | 0.25S_{M1} | 0.25S_{M1} |
| | | | ∠ 0° | ∠ 180° | ∠ 180° | ∠ 0° |
| | 1 | N6 | 0.25S_{M2} | 0.25S_{M2} | 0.25S_{M2} | 0.25S_{M2} |
| | | | ∠ 0° | ∠ 0° | ∠ 180° | ∠ 180° |
| 2 | 1 | N10 | 0.25S_{M1} | 0.25S_{M1} | 0.25S_{M1} | 0.25S_{M1} |
| | | | ∠ 0° | ∠ 0° | ∠ 0° | ∠ 0° |
| | 2 | N6 | 0.25S_{M2} | 0.25S_{M2} | 0.25S_{M2} | 0.25S_{M2} |
| | | | ∠ 0° | ∠ 0° | ∠ 180° | ∠ 180° |
| 3 | 1 | N5 | 0.25S_{M1} | 0.25S_{M1} | 0.25S_{M1} | 0.25S_{M1} |
| | | | ∠ 0° | ∠ 180° | ∠ 180° | ∠ 0° |
| | 2 | N9 | 0.25S_{M2} | 0.25S_{M2} | 0.25S_{M2} | 0.25S_{M2} |
| | | | ∠ 0° | ∠ 0° | ∠ 0° | ∠ 0° |

In Case 1, the first switch 311 connects the first input terminal 1 with the fifth node N5 and the second switch 312 connects the second input terminal 2 with the sixth node N6.

In this case, the signals with a reference phase of 0° are output through the first output terminal 3 and the fourth output terminal 6 by the first signal S_{M1} input through the first input terminal 1 and the signals with a phase delay of 180° are output through the second output terminal 4 and the third output terminal 5. Further, the signals with a reference phase of 0° are output through the first output terminal 3 and the second output terminal 4 by the second signal S_{M2} input through the second input terminal 2 and the signals with a phase delay of 180° are output through the third output terminal 5 and the fourth output terminal 6.

In Case 2, the first switch 311 connects the first input terminal 1 with the tenth node N10 and the second switch 312 connects the second input terminal 2 with the sixth node N6.

In this case, the signals with the reference phase (the same phases) of 0° are output from all of the first output terminal 3, the second output terminal 4, the third output terminal 5, and the fourth output terminal 6 by the first signal S_{M1} input through the first input terminal 1. Further, the signals with a reference phase of 0° are output through the first output terminal 3 and the second output terminal 4 by the second signal S_{M2} input through the second input terminal 2 and the signals with a phase delay of 180° are output through the third output terminal 5 and the fourth output terminal 6.

In Case 3, the first switch 311 connects the first input terminal 1 with the fifth node N5 and the second switch 312 connects the second input terminal 2 with the ninth node N9.

In this case, the signals with a reference phase of 0° are output through the first output terminal 1 and the fourth output terminal 6 by the first signal S_{M1} input through the first input terminal 1 and the signals with a phase delay of 180° are output through the second output terminal 4 and the third output terminal 5. Further, the signals with the reference phase (the same phase) of 0° are output from all of the first output terminal 3, the second output terminal 4, the third output terminal 5, and the fourth output terminal 6 by the second signal S_{M2} input through the second input terminal 2.

As described above, the structure of the third feed network 300 is similar to the structure of the first feed network 100 except that the structure in which the first input terminal 1 and the second input terminal 2 are connected with the third internal feed network 310 at the nodes N5, N6, N9, and N10 through the first switch 311 and the second switch 312. Therefore, the description of the detailed structure of the third feed network 300 refers to the description of the first feed network 100.

Meanwhile, for convenience of explanation, the configuration in which the first switch 311 and the second switch 312 are located outside the third internal feed network 310 is described, but may also be included in the third internal feed network 310.

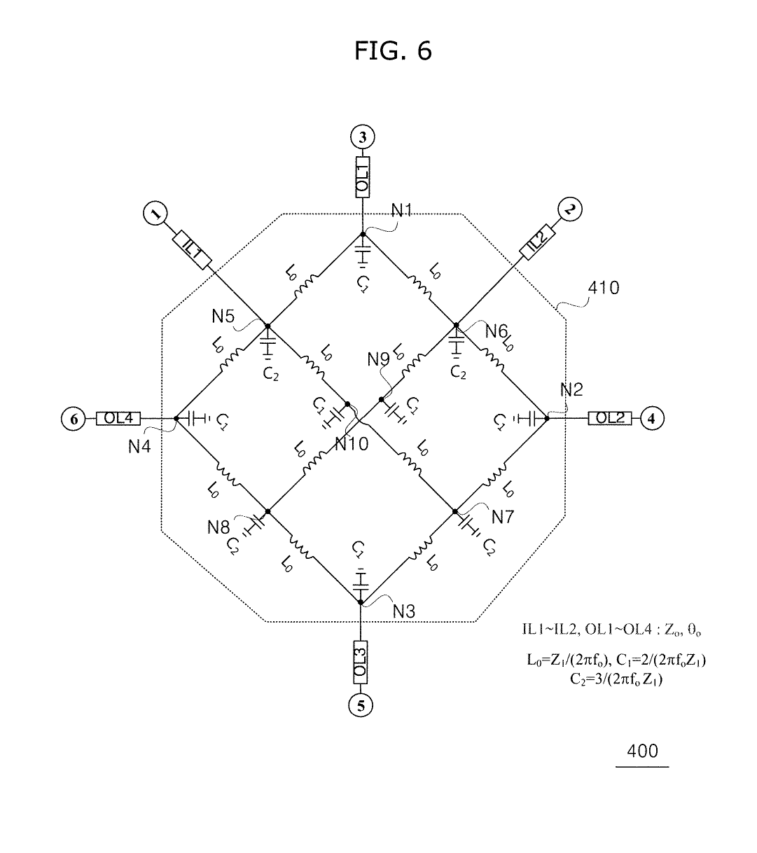

FIG. 6 is a diagram illustrating the fourth feed network for miniaturization in the communication system in accordance with the embodiment of the present invention.

Referring to FIG. 6, the fourth feed network 400 includes a fourth internal feed network 410. Further, the fourth feed network 400 includes the transmission lines IL1, IL2, OL1, OL2, OL3, and OL4 connected with the fourth internal feed network 410 and the terminals 1, 2, 3, 4, 5, and 6 connected with each of the transmission lines IL1, IL2, OL1, OL2, OL3, and OL4.

The fourth internal feed network 410 includes nodes N1, N2, N3, N4, N5, N6, N7, N8, N9, and N10. Here, the internal structure of the fourth internal feed network 410 is similar to the structure of the first internal feed network 110 of FIG. 1, but in the internal structure of the fourth internal feed network 410, inductor lumped elements L0 are located at each of the transmission elements BL1, BL2, BL3, BL4, BL5, BL6, BL7, BL8, CL1, CL2, CL3, and CL4 with the electrical length of 90°, first capacitor lumped elements C1 are connected with nodes N1, N2, N3, and N4, and second capacitor lumped elements C2 are connected with each of the nodes N5, N6, N7, N8, N9, and N10.

The inductor lumped elements L0, the first capacitor lumped elements C1, and the second capacitor lumped elements C2 configuring the fourth internal feed network 410 may be represented by the following Equation 1.

$${L}_{0} = \frac{{Z}_{1}}{2 π {f}_{0}} , \\ {C}_{1} = \frac{1}{π {f}_{0} {Z}_{1}} , \\ {C}_{2} = \frac{2}{3 π {f}_{0} {Z}_{1}} \qquad [ Equation 1 ]$$

The structure of the fourth feed network 400 is a right-handed, phase lag equivalent circuit.

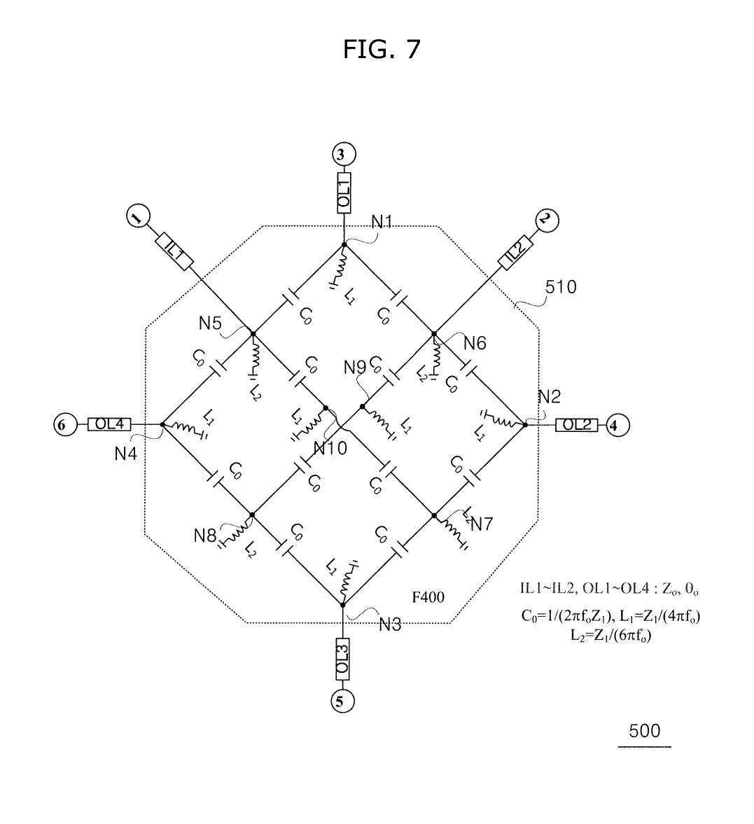

FIG. 7 is a diagram illustrating the fifth feed network for miniaturization in the communication system in accordance with the embodiment of the present invention.

Referring to FIG. 7, a fifth feed network 500 includes a fifth internal feed network 510. Further, the fifth feed network 500 includes the transmission lines IL1, IL2, OL1, OL2, OL3, and OL4 connected with the fifth internal feed network 510 and the terminals 1, 2, 3, 4, 5, and 6 connected with each of the transmission lines IL1, IL2, OL1, OL2, OL3, and OL4.

The fifth internal feed network 510 includes the nodes N1, N2, N3, N4, N5, N6, N7, N8, N9, and N10. Here, the internal structure of the fifth internal feed network 510 is similar to the structure of the first internal feed network 110 of FIG. 1, but in the internal structure of the fifth internal feed network 510, the capacitor elements C₀ are located at each of the locations of the transmission elements BL1, BL2, BL3, BL4, BL5, BL6, BL7, BL8, CL1, CL2, CL3, and CL4 with the electrical length of 90°, the first inductor lumped elements L₁ are connected with each of the nodes N1, N2, N3, and N4, and the second inductor lumped elements L₂ are connected with each of the nodes N5, N6, N7, N8, N9, and N10.

The capacitor lumped elements C₀, the first inductor lumped elements L₁, and the second inductor lumped elements L₂ configuring the fifth internal feed network 410 may be represented by the following Equation 2.

$${C}_{0} = \frac{1}{2 π {f}_{0} {Z}_{1}} , \\ {C}_{1} = \frac{{Z}_{1}}{4 π {f}_{9}} , \\ {C}_{2} = \frac{{Z}_{1}}{6 π {f}_{0}} \qquad [ Equation 2 ]$$

The structure of the fifth feed network 500 is a left-handed, phase lag equivalent circuit.

In FIGS. 6 and 7, each of the boundary transmission lines BL1, BL2, BL3, BL4, BL5, BL6, BL7, and BL8 and the cross transmission lines CL1, CL2, CL3, and CL4 are replaced with the capacitor elements (or inductor elements), the first inductor elements (or, first capacitor elements) are connected with the contacts N1, N2, N3, and N4 with which the output terminals 3, 4, 5, and 6 are connected, and the second inductor elements (or second capacitor elements) are connected with the contacts N5, N6, N7, N8, N9, and N10 of each of the boundary transmission lines BL1, BL2, BL3, BL4, BL5, BL6, BL7, and BL8 and the cross transmission lines CL1, CL2, CL3, and CL4.

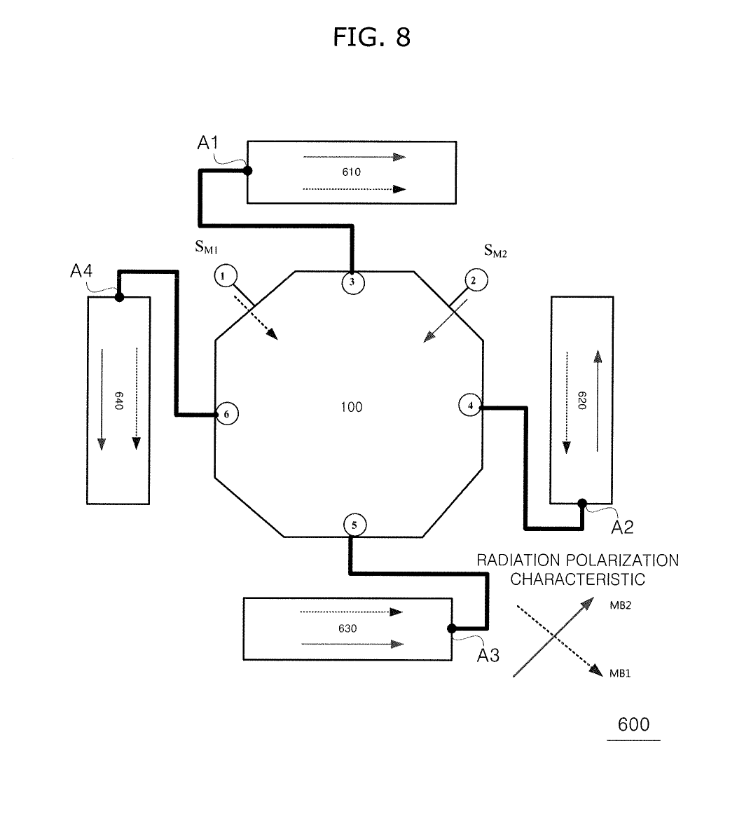

FIG. 8 is a diagram illustrating a first antenna with array antenna elements connected in a ring type in the communication system in accordance with the embodiment of the present invention and using the first feed network.

Referring to FIG. 8, a first antenna 600 includes the first feed network 100 and array antenna elements 610, 620, 630, and 640 connected with the first feed network 100.

The array antenna elements 610, 620, 630, and 640 may be arranged in a ring type so as to form the polarization diversity. Here, the array antenna elements 610, 620, 630, and 640 include various types of planar antenna elements such as a microstrip antenna element, a stack microstrip antenna element, a print dipole antenna element, and the like. In this case, the array antenna elements 610, 620, 630, and 640 may form a right angle (90°) to have orthogonal linear component between the neighbor array antenna elements. In this case, each of the array antenna elements 610, 620, 630, and 640 of the antenna includes the antenna terminals A1, A2, A3, and A4 that receive signals.

Here, the antenna terminals A1, A2, A3, and A4 are located so as to face each other or so as not to face each other and the antenna terminals A1, A2, A3, and A4 that face each other need to be located in an opposite direction to each other.

For example, the first antenna terminal A1 and the fourth antenna terminal A4 are located so as to face each other. In addition, the second antenna terminal A2 and the third antenna terminal A3 are located so as to face each other. The first antenna terminal A1 and the third antenna terminal A3 are input with signals in an opposite direction to each other. Further, the second antenna terminal A2 and the fourth antenna terminal A4 are input with signals in an opposite direction to each other.

The array antenna elements 610, 620, 630, and 640 of the first antenna 600 are combined with the first feed network 100. Therefore, in order not to deteriorate the input matching characteristics of the array antenna elements 610, 620, 630, and 640, the mutual combiing characteristics of the array antenna elements 610, 620, 630, and 640 are not present. For example, when the array antenna elements are disposed, the array antenna elements may be disposed to have the combiing characteristics of about −20 dB or less.

The first output terminal 3 of the first feed network 3 is connected with the first antenna terminal A1, the second output terminal 4 thereof is connected with the second antenna terminal A2, the third output terminal 5 thereof is connected with the third antenna terminal A3, and the fourth terminal 6 thereof is connected with the fourth antenna terminal A4.

In this case, the first signal S_{M1} input through the first input terminal 1 of the first feed network 100 is transferred to each array antenna element 610, 620, 630, and 640 through the output terminals 3, 4, 5, and 6. All the current distributions of signals output to the array antenna elements 610, 620, 630, and 640 have the same amplitude. However, the signals output through the first output terminal 3 and the fourth output terminal 6 are signals with a reference phase of 0° and the signals output through the second output terminal 4 and the third output terminal 5 are signals with a phase delay of 180°.

In this case, the polarization with patterns radiated by the signal input through the first input terminal 1 forms linear polarization of −45° (or, linear polarization of +45°) due to the spatial in field power combining of the vector signals. A first main beam MB1 illustrated in the FIG. 8 is an antenna beam propagated in a bore-sight direction radiated by the first input terminal 1.

The second signal S_{M2} input through the second input terminal 2 of the first feed network 100 is transferred to each array antenna element 610, 620, 630, and 640 through the output terminals 3, 4, 5, and 6. All the current distributions of signals output to the array antenna elements 610, 620, 630, and 640 have the same amplitude. However, the signals output through the first output terminal 3 and the second output terminal 4 are signals with a reference phase of 0° and the signals output through the third output terminal 5 and the fourth output terminal 5 are signals with a phase delay of 180°.

In this case, the polarization with patterns radiated by the signal input through the second input terminal 2 forms the linear polarization of +45° (or linear polarization of −45° due to the spatial in field power combining of the vector signals. A second main beam MB2 illustrated in FIG. 8 is an antenna beam propagated in a bore-sight direction radiated by the second input terminal 2.

Therefore, the independent signals applied through the first input terminal 1 and the second input terminal 2 are radiated to a free space in a form of the linear polarization signals that are orthogonal to each other. Therefore, the first antenna 600 may be used for polarization diversity.

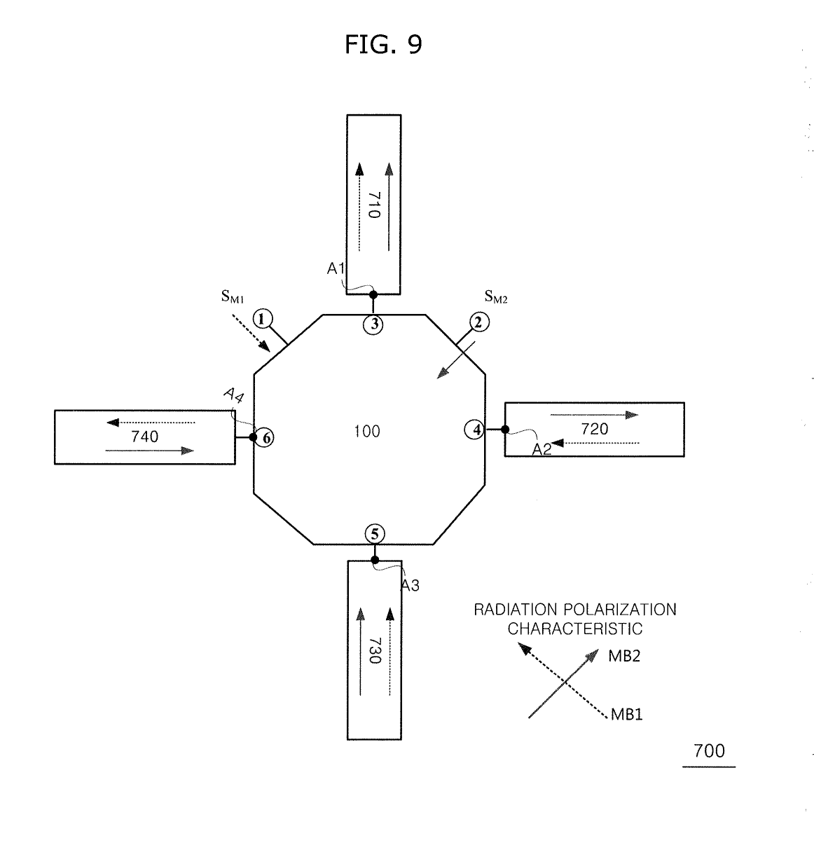

FIG. 9 is a diagram illustrating a second antenna with the array antenna elements connected in a cross type in the communication system in accordance with the embodiment of the present invention and using the first feed network.

Referring to FIG. 9, a second antenna 700 includes the first feed network 100 and array antenna elements 710, 720, 730, and 740 connected with the first feed network 100.

The array antenna elements 710, 720, 730, and 740 may be arranged in a cross type so as to form the polarization diversity. Here, the array antenna elements 710, 720, 730, and 740 include various types of planar antenna elements such as a microstrip antenna element, a stack microstrip antenna element, a print dipole antenna element, and the like. In this case, the array antenna elements 710, 720, 730, and 740 may form a right angle) (90° to have orthogonal linear component between the neighbor array antenna elements. In this case, each of the array antenna elements 710, 720, 730, and 740 includes the antenna terminals A1, A2, A3, and A4 that receive signals.

Here, the array antenna elements 710, 720, 730, and 740 need to be located in an opposite direction (for example, an opposite direction of the first feed network (a vertical direction in the FIG. 9)) of the first feed network based on the antenna terminals A1, A2, A3, and A4.

For example, the first antenna terminal A1 and the third antenna terminal A3 are located so as to face each other. In addition, the second antenna terminal A2 and the fourth antenna terminal A3 are located so as to face each other. The first antenna terminal A1 and the third antenna terminal A3 are input with signals in an opposite direction to each other. Further, the second antenna terminal A2 and the fourth antenna terminal A4 are input with signals in an opposite direction to each other.

The second antenna 700 is combined with the array antenna elements 710, 720, 730, and 740 in the first feed network 100. Therefore, in order not to deteriorate the input matching characteristics of the array antenna elements 710, 720, 730, and 740, the mutual combining characteristics between the array antenna elements 710, 720, 730, and 740 need not to be present. For example, when the array antenna elements 710, 720, 730, and 740 are disposed, the array antenna elements may be disposed to have the combining characteristics of about −20 dB or less.

The first output terminal 3 of the first feed network 100 is connected with the first antenna terminal A1, the second output terminal 4 thereof is connected with the second antenna terminal A2, the third output terminal 5 thereof is connected with the third antenna terminal A3, and the fourth terminal 6 thereof is connected with the fourth antenna terminal A4.

In this case, the first signal S_{M1} input through the first input terminal 1 of the first feed network 100 is transferred to each array antenna element 710, 720, 730, and 740 through the output terminals 3, 4, 5, and 6. All the current distributions of signals output to the array antenna elements 710, 720, 730, and 740 have the same amplitude. However, the signals output through the first output terminal 3 and the fourth output terminal 6 are signals with a reference phase of 0° and the signals output through the second output terminal 4 and the third output terminal 5 are signals with a phase delay of 180°.

In this case, the polarization with patterns radiated by the signal input through the second input terminal 1 forms the linear polarization of −45° (or linear polarization of +45°) due to the spatial in field power combining of the vector signals. The first main beam MB1 illustrated in FIG. 9 is an antenna beam propagated in a bore-sight direction radiated by the first input terminal 1.

The second signal S_{M2} input through the second input terminal 2 of the first feed network 100 is transferred to each array antenna element 710, 720, 730, and 740 through the output terminals 3, 4, 5, and 6. All the current distributions of signals output to the array antenna elements 710, 720, 730, and 740 have the same amplitude. However, the signals output through the first output terminal 3 and the second output terminal 6 are signals with a reference phase of 0° and the signals output through the third output terminal 4 and the fourth output terminal 5 are signals with a phase delay of 180°.

In this case, the polarization with patterns radiated by the signal input through the second input terminal 2 forms the linear polarization of +45° (or linear polarization of −45° due to the spatial in field power combining of the vector signals. A second main beam MB2 illustrated in the FIG. 9 is an antenna beam propagated in a bore-sight direction radiated by the second input terminal 2.

Therefore, the independent signals applied through the first input terminal 1 and the second input terminal 2 are radiated to a free space in a form of the linear polarization signals that are orthogonal to each other. Therefore, the second antenna 700 may be used for polarization diversity.

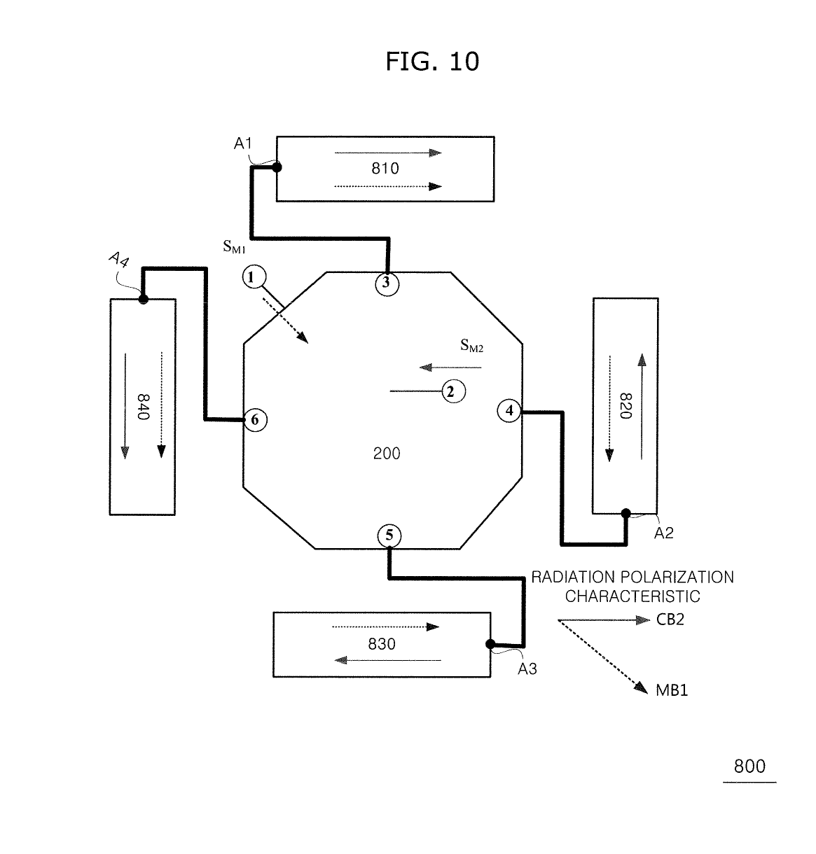

FIG. 10 is a diagram illustrating a third antenna with array antenna elements connected in a ring type in the communication system in accordance with the embodiment of the present invention and using the second feed network.

Referring to FIG. 10, a third antenna 800 includes the second feed network 200 and array antenna elements 810, 820, 830, and 840 connected with the second feed network 200.

The array antenna elements 810, 820, 830, and 840 may be arranged in a ring type so as to form the polarization diversity. Here, the third antenna 800 is similar to the structure of the first antenna 600 of FIG. 8 and therefore, the description of the structure of the array antenna elements 810, 820, 830, and 840 refers to the description of the first antenna 600.

In this case, each of the array antenna elements 810, 820, 830, and 840 includes the antenna terminals A1, A2, A3, and A4 that receive signals.

Here, the antenna terminals A1, A2, A3, and A4 are located so as to face each other or so as not to face each other and the antenna terminals A1, A2, A3, and A4 that face each other need to be located in an opposite direction to each other.

In this case, the first signal S_{M1} input through the first input terminal 1 of the second feed network 200 is transferred to each array antenna element 810, 820, 830, and 840 through the output terminals 3, 4, 5, and 6. All the current distributions of signals output to the array antenna elements 810, 820, 830, and 840 have the same amplitude. However, the signals output through the first output terminal 3 and the fourth output terminal 6 are signals with a reference phase of 0° and the signals output through the second output terminal 4 and the third output terminal 5 are signals with a phase delay of 180°.

In this case, the polarization with patterns radiated by the signal input through the second input terminal 1 forms the linear polarization of −45° (or linear polarization of +45°) due to the spatial in field power combining of the vector signals. The first main beam MB1 illustrated in FIG. 10 is an antenna beam propagated in a bore-sight direction radiated by the first input terminal 1.

The second signal S_{M2} input through the second input terminal 2 of the second feed network 200 is transferred to each array antenna element 810, 820, 830, and 840 through the output terminals 3, 4, 5, and 6. All the current distributions of signals output to the array antenna elements 810, 820, 830, and 840 have the same amplitude. All the signals output through the first output terminal 3 and the fourth output terminal 6 are signals with a reference phase of 0°.

In this case, the polarization with patterns radiated by the signal input through the second input terminal 2 becomes null in a bore-sight direction due to the spatial in field power combining of the vector signals and forms a conical beam pattern with an omni-directional characteristic in an azimuth direction. That is, the polarization with patterns radiated by the signal input through the second input terminal 2 forms the horizontal polarization. A second conical beam 2 illustrated in FIG. 10 is an antenna beam in a conical direction formed by the second input terminal 2.

Therefore, the independent signals applied through the first input terminal 1 and the second input terminal 2 have the radiation patterns that are orthogonal to each other. Therefore, the third antenna 800 may be used for polarization diversity.

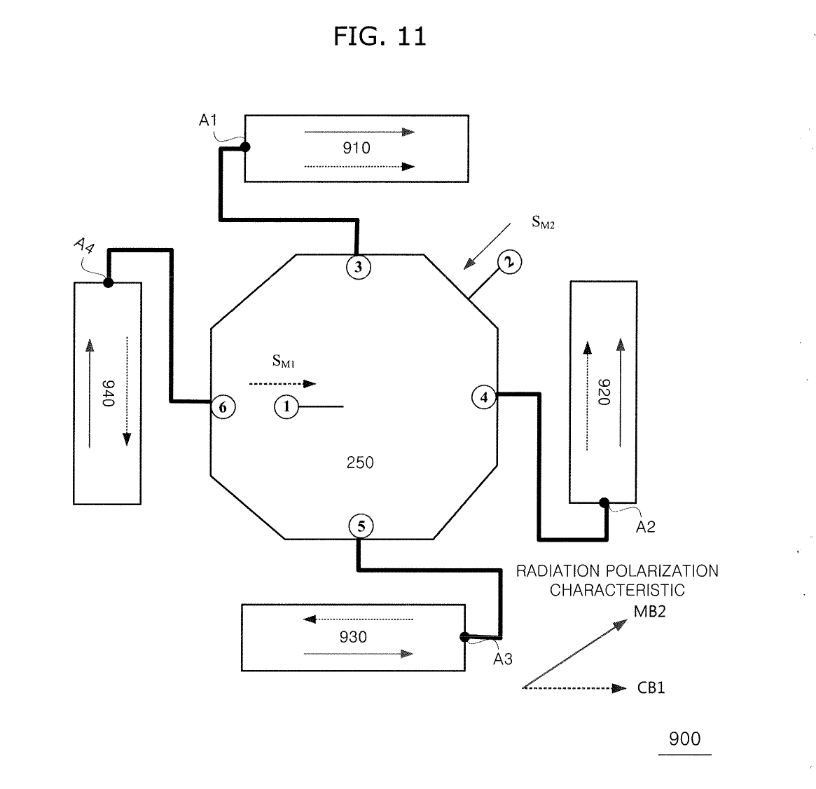

FIG. 11 is a diagram illustrating a fourth antenna with the array antenna elements connected in a ring type in the communication system in accordance with the embodiment of the present invention and using a changed second feed network.

Referring to FIG. 11, a fourth antenna 900 includes a changed second feed network 250 and array antenna elements 910, 920, 930, and 940 connected with the changed second feed network 250.

Here, the changed second feed network 250 is a feed network with a structure in which the input terminals of the second feed network 200 are exchanged with each other. Therefore, the first input terminal 1 is connected with contacts of the cross transmission lines of the center of the feed network and the second input terminal 2 is connected with contacts of the boundary transmission lines outside the feed network.

The structure of the fourth antenna 900 is similar to the structure of the third antenna 800 except that the fourth antenna 900 includes the changed second feed network 250 as compared with the third antenna 800 of FIG. 10 and therefore, the detailed description thereof refers to the description of the third antenna 800.

In this case, the first signal S_{M1} input through the first input terminal 1 of the changed second feed network 250 is transferred to each array antenna element 910, 920, 930, and 940 through the output terminals 3, 4, 5, and 6. All the current distributions of signals output to the array antenna elements 910, 920, 930, and 940 have the same amplitude. All the signals output through the first output terminal 3 and the fourth output terminal 6 are signals with a reference phase of 0°.

In this case, the polarization with patterns radiated by the signal input through the first input terminal 1 becomes null in a bore-sight direction due to the spatial in field power combining of the vector signals and forms a conical beam pattern with an omni-directional characteristic in an azimuth direction. That is, the polarization with patterns radiated by the signal input through the first input terminal 1 forms the horizontal polarization. The first conical beam 1 illustrated in FIG. 11 is an antenna beam in a conical direction generated by the first input terminal 1.

The second signal S_{M2} input through the second input terminal 2 of the changed second feed network 250 is transferred to each array antenna element 910, 920, 930, and 940 through the output terminals 3, 4, 5, and 6. All the current distributions of signals output to the array antenna elements 910, 920, 930, and 940 have the same amplitude. However, the signals output through the first output terminal 3 and the second output terminal 4 are signals with a reference phase of 0° and the signals output through the third output terminal 5 and the fourth output terminal 6 are signals with a phase delay of 180°.

In this case, the polarization with patterns radiated by the signal input through the second input terminal 2 forms the linear polarization of −45° (or linear polarization of +45°) due to the spatial in field power combining of the vector signals. The second main beam MB2 illustrated in FIG. 11 is an antenna beam propagated in a bore-sight direction radiated by the second input terminal 2.

Therefore, the independent signals applied through the first input terminal 1 and the second input terminal 2 have the radiation patterns that are orthogonal to each other. Therefore, the fourth antenna 900 may be used for polarization diversity.

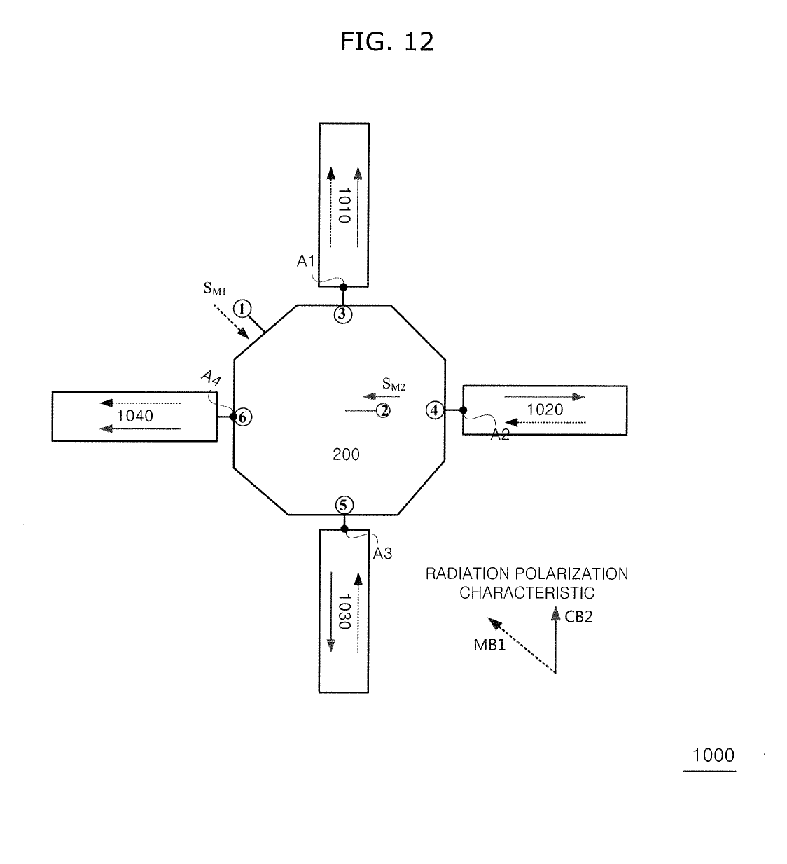

FIG. 12 is a diagram illustrating a fifth antenna with the array antenna elements connected in a cross type in the communication system in accordance with the embodiment of the present invention and using the second feed network.

Referring to FIG. 12, a fifth antenna 1000 includes the second feed network 200 and array antenna elements 1010, 1020, 1030, and 1040 connected with the second feed network 200.

The array antenna elements 1010, 1020, 1030, and 1040 may be arranged in a cross type so as to form the polarization diversity. Here, the array antenna elements 1010, 1020, 1030, and 1040 include various types of planar antenna elements such as a microstrip antenna element, a stack microstrip antenna element, a print dipole antenna element, and the like. In this case, the array antenna elements 1010, 1020, 1030, and 1040 may form a right angle) (90° to have orthogonal linear component between the neighbor array antenna elements. In this case, each of the array antenna elements 1010, 1020, 1030, and 1040 includes the antenna terminals A1, A2, A3, and A4 that receive signals.

Here, the antenna terminals A1, A2, A3, and A4 need to be located in an opposite direction (for example, a vertical direction in FIG. 11) to each other.

For example, the first antenna terminal A1 and the third antenna terminal A3 are located so as to face each other. In addition, the second antenna terminal A2 and the fourth antenna terminal A3 are located so as to face each other. The first antenna terminal A1 and the third antenna terminal A3 are input with signals in an opposite direction to each other. Further, the second antenna terminal A2 and the fourth antenna terminal A4 are input with signals in an opposite direction to each other.

The fifth antenna 1000 is combined with the array antenna elements 1010, 1020, 1030, and 1040 in the second feed network 200. Therefore, in order not to deteriorate the input matching characteristics of the array antenna elements 1010, 1020, 1030, and 1040, the mutual combining characteristics between the array antenna elements needs not to be present. For example, when the array antenna elements are disposed, the array antenna elements may be disposed to have the combining characteristics of about −20 dB or less.

The first output terminal 3 of the second feed network 200 is connected with the first antenna terminal A1, the second output terminal 4 thereof is connected with the second antenna terminal A2, the third output terminal 5 thereof is connected with the third antenna terminal A3, and the fourth terminal 6 thereof is connected with the fourth antenna terminal A4.

In this case, the first signal S_{M1} input through the first input terminal 1 of the second feed network 200 is transferred to each array antenna element 1010, 1020, 1030, and 1040 through the output terminals 3, 4, 5, and 6. All the current distributions of signals output to the array antenna elements 1010, 1020, 1030, and 1040 have the same amplitude. However, the signals output through the first output terminal 3 and the fourth output terminal 6 are signals with a reference phase of 0° and the signals output through the second output terminal 4 and the third output terminal 5 are signals with a phase delay of 180°.

In this case, the polarization with patterns radiated by the signal input through the first input terminal 1 forms the linear polarization of −45° (or linear polarization of +45°) due to the spatial in field power combining of the vector signals. The first main beam MB1 illustrated in FIG. 12 is an antenna beam propagated in a bore-sight direction radiated by the first input terminal 1.

The second signal S_{M2} input through the second input terminal 2 of the second feed network 200 is transferred to each array antenna element 610, 620, 630, and 640 through the output terminals 3, 4, 5, and 6. All the current distributions of signals output to the array antenna elements 610, 620, 630, and 640 have the same amplitude. However, all the signals output through the first output terminal 3 and the fourth output terminal 6 are signals with a reference phase of 0°.

In this case, the polarization with patterns radiated by the signal input through the second input terminal 2 becomes null in a bore-sight direction due to the spatial in field power combining of the vector signals and forms a conical beam pattern with an omni-directional characteristic in an azimuth direction. That is, the polarization with patterns radiated by the signal input through the second input terminal 2 forms the vertical polarization. The second conical beam 2 illustrated in FIG. 12 is an antenna beam in a conical direction formed by the second input terminal 2.

Therefore, the independent signals applied through the first input terminal 1 and the second input terminal 2 are radiated to a free space in a form of the linear polarization signals that are orthogonal to each other. Therefore, the fifth antenna 1000 may be used for polarization diversity.

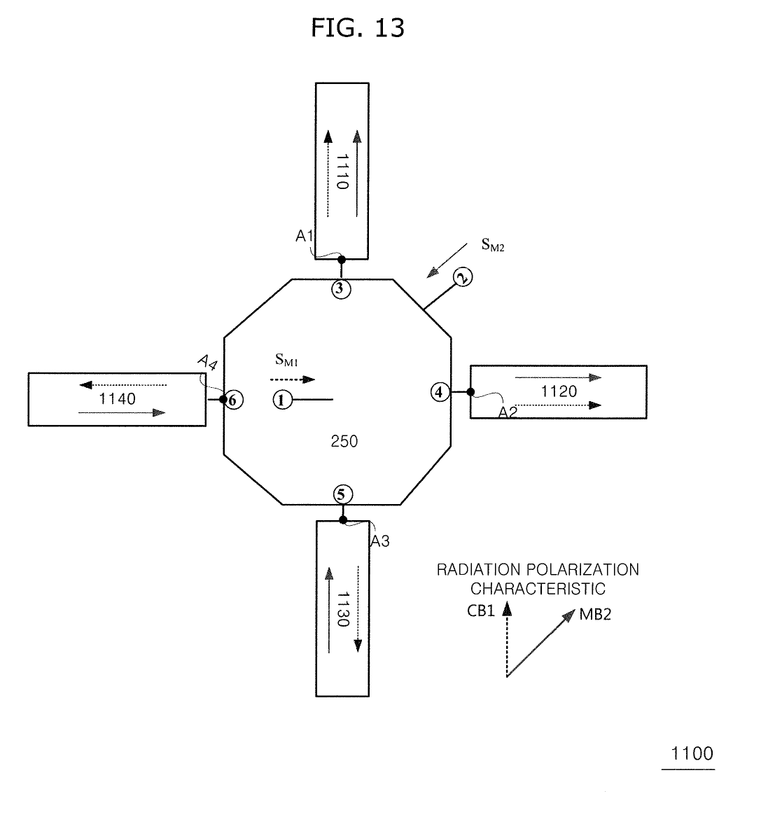

FIG. 13 is a diagram illustrating a sixth antenna with the array antenna elements connected in a cross type in the communication system in accordance with the embodiment of the present invention and using the changed second feed network.

Referring to FIG. 13, a sixth antenna 1100 includes the changed second feed network 250 and array antenna elements 1110, 1120, 1130, and 1140 connected with the changed second feed network 250.

Here, the changed second feed network 250 is a feed network with a structure in which the input terminals of the second feed network 200 are exchanged with each other. Therefore, the first input terminal 1 is connected with contacts of the cross transmission lines of the center of the feed network and the second input terminal 2 is connected with contacts of the boundary transmission lines outside the feed network.

The structure of the sixth antenna 1100 is similar to the structure of the third antenna 1000 except that the sixth antenna 110 includes the changed second feed network 250 as compared with the fifth antenna 1000 of FIG. 12 and therefore, the detailed description thereof refers to the description of the fifth antenna 1000.

In this case, the first signal S_{M1} input through the first input terminal 1 of the changed second feed network 250 is transferred to each array antenna element 1110, 1120, 1130, and 1140 through the output terminals 3, 4, 5, and 6. All the current distributions of signals output to the array antenna elements 1110, 1120, 1130, and 1140 have the same amplitude. All the signals output through the first output terminal 3 and the fourth output terminal 6 are signals with a reference phase of 0°.

In this case, the polarization with patterns radiated by the signal input through the first input terminal 1 becomes null in a bore-sight direction due to the spatial in field power combining of the vector signals and forms a conical beam pattern with an omni-directional characteristic in an azimuth direction. That is, the polarization with patterns radiated by the signal input through the first input terminal 1 forms the vertical polarization. The first conical beam 1 illustrated in FIG. 13 is an antenna beam in a conical direction generated by the first input terminal 1.

The second signal S_{M2} input through the second input terminal 2 of the second feed network 200 is transferred to each array antenna element 1110, 1120, 1130, and 1140 through the output terminals 3, 4, 5, and 6. All the current distributions of signals output to the array antenna elements 1110, 1120, 1130, and 1140 have the same amplitude. However, the signals output through the first output terminal 3 and the second output terminal 4 are signals with a reference phase of 0° and the signals output through the third output terminal 5 and the fourth output terminal 6 are signals with a phase delay of 180°.

In this case, the polarization with patterns radiated by the signal input through the second input terminal 2 forms the linear polarization of −45° (or linear polarization of +45°) due to the spatial in field power combining of the vector signals. The second main beam MB2 illustrated in FIG. 13 is an antenna beam propagated in a bore-sight direction radiated by the second input terminal 2.

Therefore, the independent signals applied through the first input terminal 1 and the second input terminal 2 are radiated to a free space in a form of the linear polarization signals that are orthogonal to each other. Therefore, the sixth antenna 1100 may be used for polarization diversity.

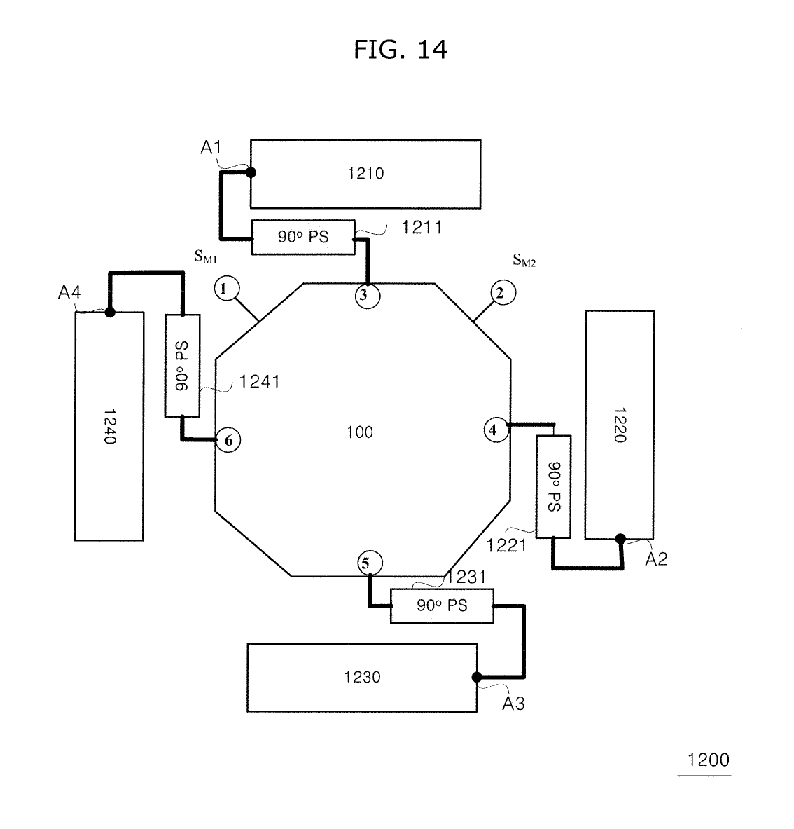

FIG. 14 is a diagram illustrating a seventh antenna including 90° phase shifters in the communication system in accordance with the embodiment of the present invention.

Referring to FIG. 14, a seventh antenna 1200 includes the first feed network 100, array antenna elements 1210, 1220, 1230, and 1240, and phase shifters 1211, 1221, 1231, and 1241.

The seventh antenna 1200 has a structure similar to the first antenna 600 of FIG. 8 except for the structure of the phase shifters 1211, 1221, 1231, and 1241 located between the first feed network 100 and the array antenna elements 1210, 1220, 1230, and 1240.

Therefore, the description of the remaining structure except for the structure of the phase shifters 1211, 1221, 1231, and 1241 refers to the description of the first antenna 600.

The first phase shifter 1211 is located between the first output terminal 3 and the first antenna terminal A1. The second phase shifter 1221 is located between the second output terminal 4 and the second antenna terminal A2. The third phase shifter 1231 is located between the third output terminal 5 and the third antenna terminal A3. The fourth phase shifter 1241 is located between the fourth output terminal 6 and the fourth antenna terminal A4.

Here, the phase shifters 1211, 1221, 1231, and 1241 shift phases of signals input to the array antenna elements 1210, 1220, 1230, and 1240 as much as 90°. Therefore, the phase shifters 1210, 1220, 1230, and 1240 are the 90° phase shifters.

Here, when the phase shifters 1211, 1221, 1231, and 1241 are the phase shifters that shift a phase as much as 90°, the seventh antenna 1200 has the same structure as the first antenna 600.

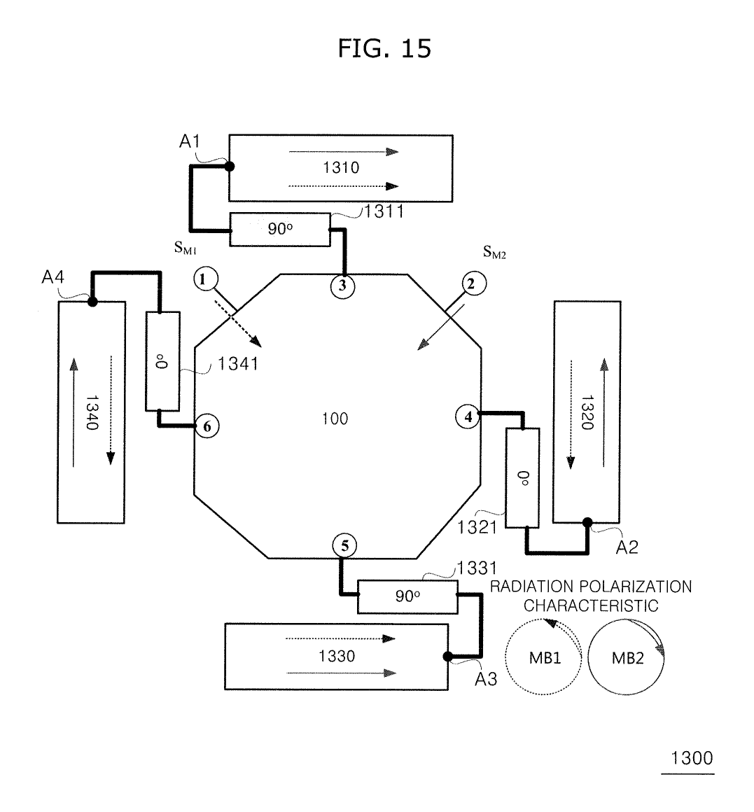

FIG. 15 is a diagram illustrating an eighth antenna including 0° phase shifters and 90° phase shifters in the communication system in accordance with the embodiment of the present invention.

Referring to FIG. 15, an eighth antenna 1300 includes the first feed network 100, array antenna elements 1310, 1320, 1330, and 1340, and phase shifters 1311, 1321, 1331, and 1341.

The eighth antenna 1300 has a structure similar to the first antenna 600 of FIG. 8 except for the structure of the phase shifters 1311, 1321, 1331, and 1341 located between the first feed network 100 and the array antenna elements 1310, 1320, 1330, and 1340.

Therefore, the description of the remaining structure except for the structure of the phase shifters 1311, 1321, 1331, and 1341 refers to the description of the first antenna 600.

The first phase shifter 1311 is located between the first output terminal 3 and the first antenna terminal A1. The second phase shifter 1321 is located between the second output terminal 4 and the second antenna terminal A2. The third phase shifter 1331 is located between the third output terminal 5 and the third antenna terminal A3. The fourth phase shifter 1341 is located between the fourth output terminal 6 and the fourth antenna terminal A4.

Here, the second phase shifter 1321 and the fourth phase shifter 1341 are the 0° phase shifters and the first phase shifter 1311 and the third phase shifter 1331 are the 90° phase shifters. That is, the first phase shifters 1311 and the third phase shifters 1331 lead the phases of the signals output to the array antenna elements 1310 and 1330 as much as 90°

Here, the first signal S_{M1} input through the first input terminal 1 forms the first main beam MB1 pattern in a bore-sight direction with a left polarization (or right polarization) In addition, the second signal S_{M2} input through the second input terminal 2 forms the second main beam MB2 pattern in a bore-sight direction with a right polarization (or left polarization).

Therefore, the independent signals applied through the first input terminal 1 and the second input terminal 2 are radiated to a free space in a form of the linear polarization signals or the orthogonal circular polarization signals that are orthogonal to each other. Therefore, the eighth antenna 1300 may be used for polarization diversity.

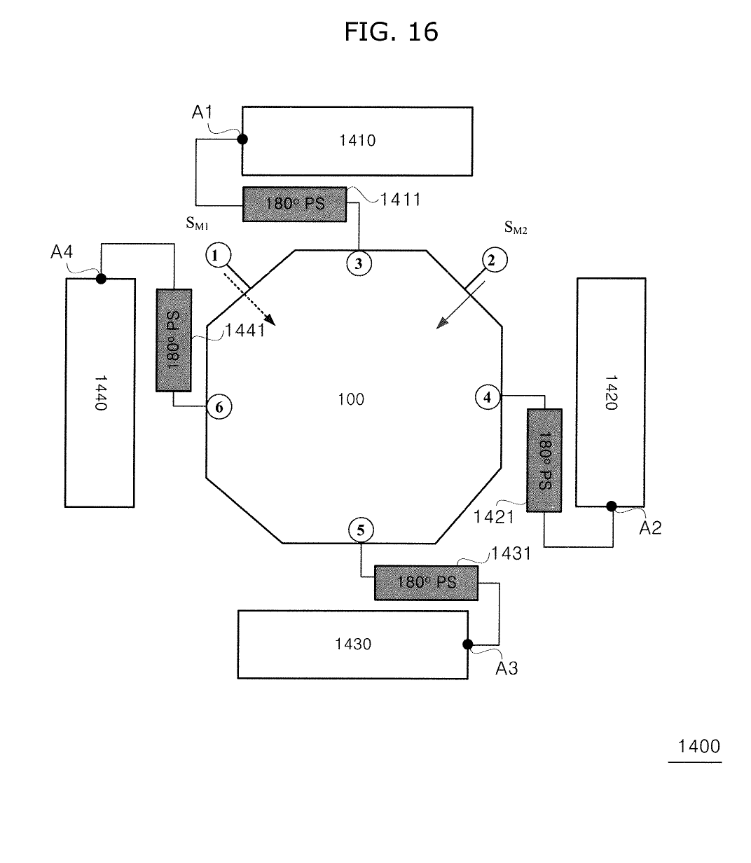

FIG. 16 is a diagram illustrating a ninth antenna including 180° phase shifters in the communication system in accordance with the embodiment of the present invention.

Referring to FIG. 16, a ninth antenna 1400 includes the first feed network 100, array antenna elements 1410, 1420, 1430, and 1440, and phase shifters 1411, 1421, 1431, and 1441.

The ninth antenna 1400 has a structure similar to the first antenna 600 of FIG. 8 except for the structure of the phase shifters 1411, 1421, 1431, and 1441 located between the first feed network 100 and the array antenna elements 1410, 1420, 1430, and 1440.

Therefore, the description of the remaining structure except for the structure of the phase shifters 1411, 1421, 1431, and 1441 refers to the description of the first antenna 600.

The first phase shifter 1411 is located between the first output terminal 3 and the first antenna terminal A1. The second phase shifter 1421 is located between the second output terminal 4 and the second antenna terminal A2. The third phase shifter 1431 is located between the third output terminal 5 and the third antenna terminal A3. The fourth phase shifter 1441 is located between the fourth output terminal 6 and the fourth antenna terminal A4.

Here, the phase shifters 1411, 1421, 1431, and 1441 are the 180° phase shifters.

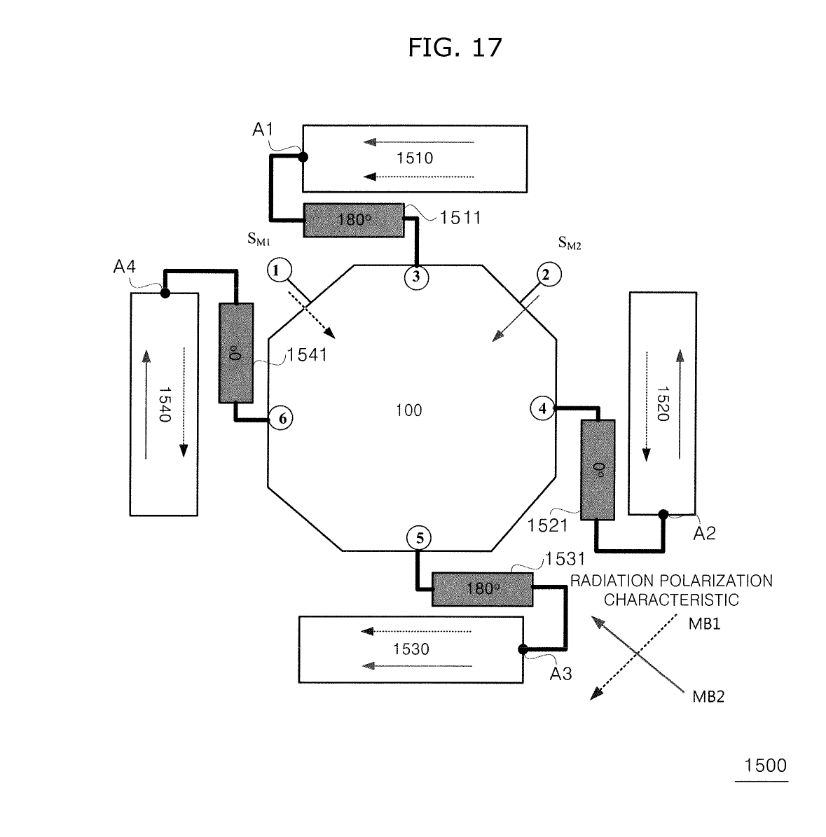

FIG. 17 is a diagram illustrating a tenth antenna including 0° phase shifters and 180° phase shifters in the communication system in accordance with the embodiment of the present invention.

Referring to FIG. 17, a tenth antenna 1500 includes the first feed network 100, array antenna elements 1510, 1520, 1530, and 1540, and phase shifters 1511, 1521, 1531, and 1541.

The tenth antenna 1500 has a structure similar to the first antenna 600 of FIG. 8 except for the structure of the phase shifters 1511, 1521, 1531, and 1541 located between the first feed network 100 and the array antenna elements 1510, 1520, 1530, and 1540.

Therefore, the description of the remaining structure except for the structure of the phase shifters 1511, 1521, 1531, and 1541 refers to the description of the first antenna 600.

The first phase shifter 1511 is located between the first output terminal 3 and the first antenna terminal A1. The second phase shifter 1521 is located between the second output terminal 4 and the second antenna terminal A2. The third phase shifter 1531 is located between the third output terminal 5 and the third antenna terminal A3. The fourth phase shifter 1541 is located between the fourth output terminal 6 and the fourth antenna terminal A4.

Here, the second phase shifter 1521 and the fourth phase shifter 1541 are the 0° phase shifters and the first phase shifter 1511 and the third phase shifter 1531 are the 180° phase shifters. Here, the first phase shifter 1511 and the third phase shifter 1531 lead (lag) the phases of the signals output to the array antenna elements 1510 and 1530 as much as 180°.

Here, the first signal S_{M1} input through the first input terminal 1 forms the first main beam MB1 pattern in a bore-sight direction with a left polarization (or right polarization) In addition, the second signal S_{M2} input through the second input terminal 2 forms the second main beam MB2 pattern in a bore-sight direction with a right polarization (or left polarization).

Therefore, the independent signals applied through the first input terminal 1 and the second input terminal 2 are radiated to a free space in a form of the linear polarization signals that are orthogonal to each other. Therefore, the tenth antenna 1500 may be used for polarization diversity.

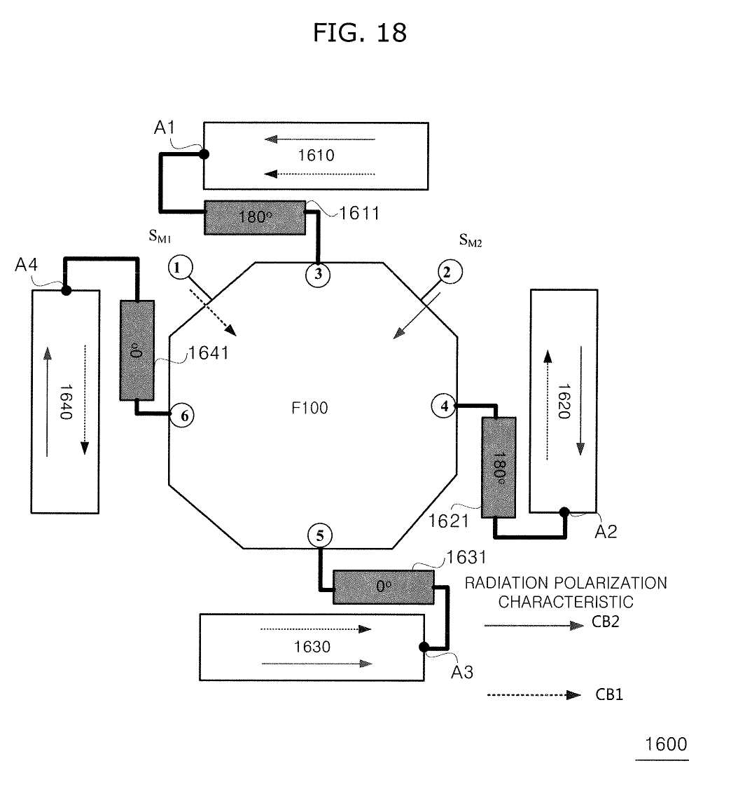

FIG. 18 is a diagram illustrating an eleventh antenna including 0° phase shifters and 180° phase shifters in the communication system in accordance with the embodiment of the present invention.

Referring to FIG. 18, an eleventh antenna 1600 includes the first feed network 100, array antenna elements 1610, 1620, 1630, and 1640, and phase shifters 1611, 1621, 1631, and 1641.

The eleventh antenna 1600 has a structure similar to the first antenna 600 of FIG. 8 except for the structure of the phase shifters 1611, 1621, 1631, and 1641 located between the first feed network 100 and the array antenna elements 1610, 1620, 1630, and 1640.

Therefore, the description of the remaining structure except for the structure of the phase shifters 1611, 1621, 1631, and 1641 refers to the description of the first antenna 600.

The first phase shifter 1611 is located between the first output terminal 3 and the first antenna terminal A1. The second phase shifter 1621 is located between the second output terminal 4 and the second antenna terminal A2. The third phase shifter 1631 is located between the third output terminal 5 and the third antenna terminal A3. The fourth phase shifter 1641 is located between the fourth output terminal 6 and the fourth antenna terminal A4.

Here, the first phase shifter 1611 and the second phase shifter 1621 are the 180° phase shifters and the third phase shifter 1631 and the fourth phase shifter 1641 are the 0° phase shifters. Here, the first phase shifter 1611 and the second phase shifter 1621 lead (lag) the phases of the signals output to the array antenna elements 1610 and 1630 as much as 180°.

Here, the first signal S_{M1} input through the first input terminal 1 forms the first conical beam CB1 pattern with the horizontal polarization. In addition, the second signal S_{M2} input through the second input terminal 2 forms the second conical beam CB2 pattern with the horizontal polarization.

Therefore, the independent signals applied through the first input terminal 1 and the second input terminal 2 are radiated to a free space in a form of the two linear polarization signals that are orthogonal to each other or one horizontal polarization signal. Therefore, the eleventh antenna 1600 may be used for polarization diversity.

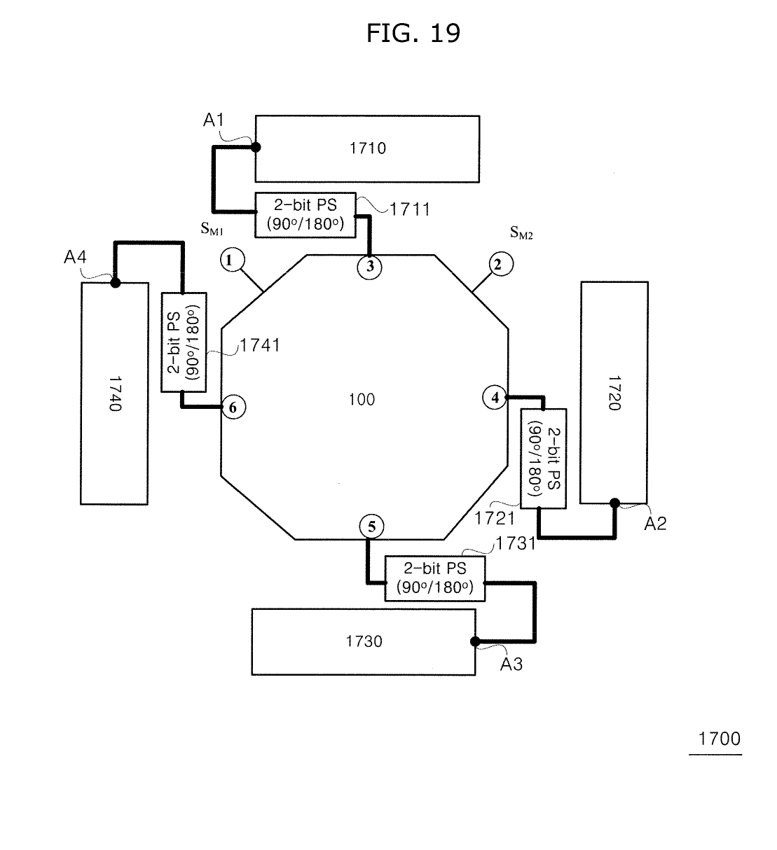

FIG. 19 is a diagram illustrating a twelfth antenna including 90°/180° phase shifters in the communication system in accordance with the embodiment of the present invention.

Referring to FIG. 19, a twelfth antenna 1700 includes the first feed network 100, array antenna elements 1710, 1720, 1730, and 1740, and phase shifters 1711, 1721, 1731, and 1741.

The twelfth antenna 1700 has a structure similar to the first antenna 600 of FIG. 8 except for the structure of the phase shifters 1711, 1721, 1731, and 1741 located between the first feed network 100 and the array antenna elements 1710, 1720, 1730, and 1740.

Therefore, the description of the remaining structure except for the structure of the phase shifters 1711, 1721, 1731, and 1741 refers to the description of the first antenna 600.

The first phase shifter 1711 is located between the first output terminal 3 and the first antenna terminal A1. The second phase shifter 1721 is located between the second output terminal 4 and the second antenna terminal A2. The third phase shifter 1731 is located between the third output terminal 5 and the third antenna terminal A3. The fourth phase shifter 1741 is located between the fourth output terminal 6 and the fourth antenna terminal A4.

Here, the first phase shifter 1711 to the fourth phase shifter 1741 are the 90°/180° phase shifters. Two-bit phase shifter such as the first phase shifter 1711 to the fourth phase shifter 1741 may be set to be one of 90° or 180°. In this way, the second antenna 1700 may form the main beam pattern with two orthogonal linear polarizations or the circular polarization and the conical beam pattern with the horizontal polarization, thereby selectively the polarization diversity or the pattern diversity simultaneously.

The two polarization signals in which two independent input signals are orthogonal to each other or the two beam patterns (main beam pattern and conical beam pattern) signals with peak values in different directions are generated by the foregoing antennas 600 to 1700 and the generated signals are radiated to the free space. The antennas 600 to 1700 may be used as a 2×2 MIMO antenna structure that requires the high scattering wireless channel environment.

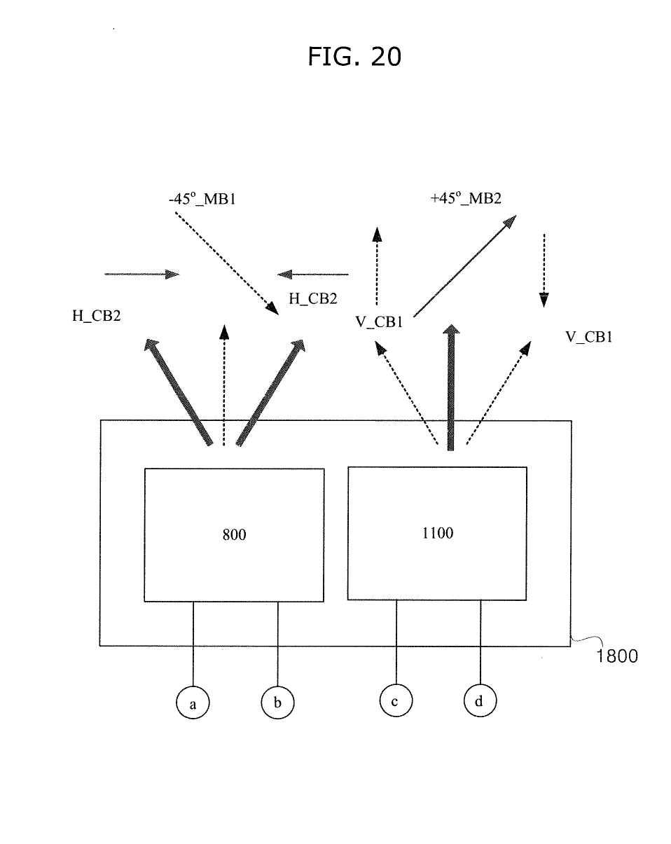

FIG. 20 is a conceptual diagram of a thirteenth antenna with a 4×4 MIMO antenna structure in the communication system in accordance with the embodiment of the present invention.

Referring to FIG. 20, the thirteenth antenna 1800 includes the third antenna 800 and the sixth antenna 1100. In addition, the third thirteenth antenna 1800 includes input terminals a, b, c, and d.

The thirteenth antenna 1800 generates the linear polarization signal of −45° (first main beam −45°_MB1) and the horizontal polarization signal (second conical beam H_CB2) by the third antenna 800 structure. The thirteenth antenna 1800 generates the vertical polarization signal (first conical beam V_CB1) and the linear polarization signal of +45° (second conical beam +45°_MB2) by the sixth antenna 1100 structure.

Four signals input through the input terminals a, b, c, and d from the thirteen antenna 1800 have four independent radiation characteristics and are radiated to the free space. Therefore, the thirteenth antenna 1800 is a 4×4 MIMO antenna.

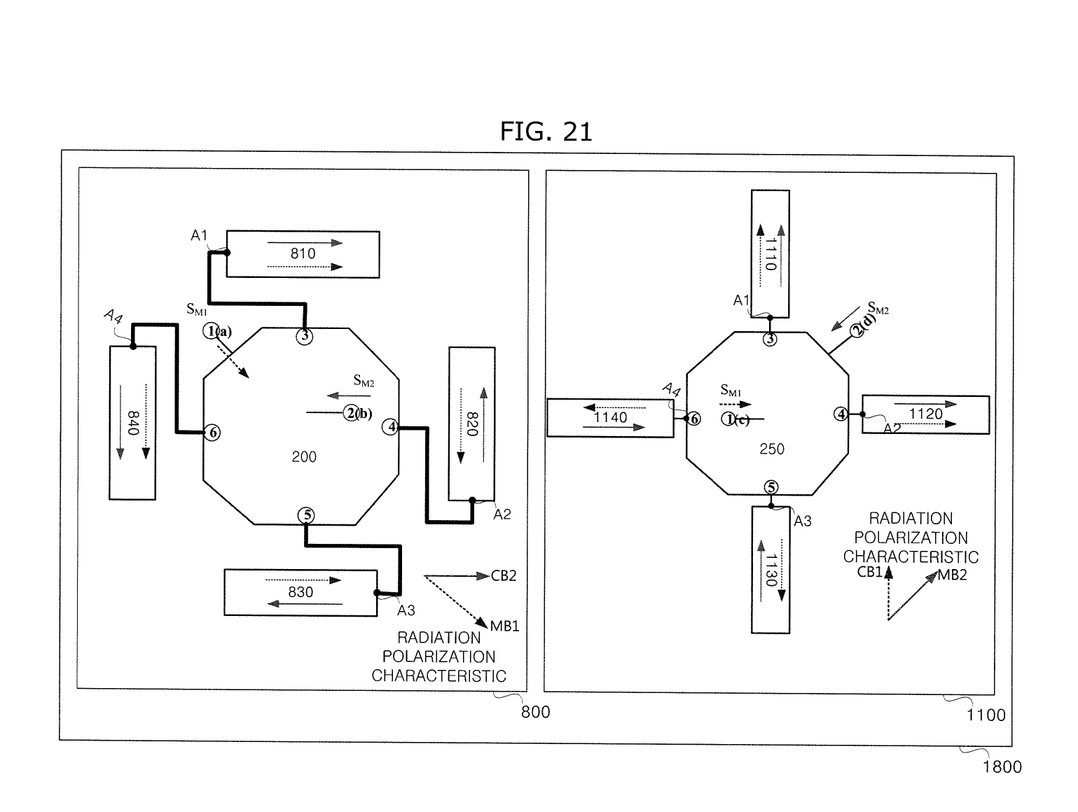

FIG. 21 is a diagram illustrating the thirteenth antenna structure of FIG. 20.

Referring to FIG. 21, the thirteenth antenna 1800 has a structure in which the third antenna 800 is connected with the sixth antenna 1100.

In this case, the description of the structure of the thirteenth antenna 1800 refers to the description of the third antenna 800 and the sixth antenna 1100.

A first input terminal a of the thirteenth antenna 1800 corresponds to the first input terminal 1 of the third antenna 800 and a second input terminal b thereof corresponds to the second input terminal 2 of the third antenna 800. As described above, a third input terminal c of the thirteenth antenna 1800 corresponds to the first input terminal 1 of the sixth antenna 1100 and a fourth input terminal d corresponds to the second input terminal 2 of the sixth antenna 1100.

In this way, the linear polarization signal of −45° (first main beam −45°_MB1) and the horizontal polarization signal (second conical beam H_CB2) are generated by the third antenna 800 structure. Further, the vertical polarization signal (first conical beam V_CB1) and the linear polarization signal of 45° (second main beam +45°_MB2) are generated by the sixth antenna 1100 structure.

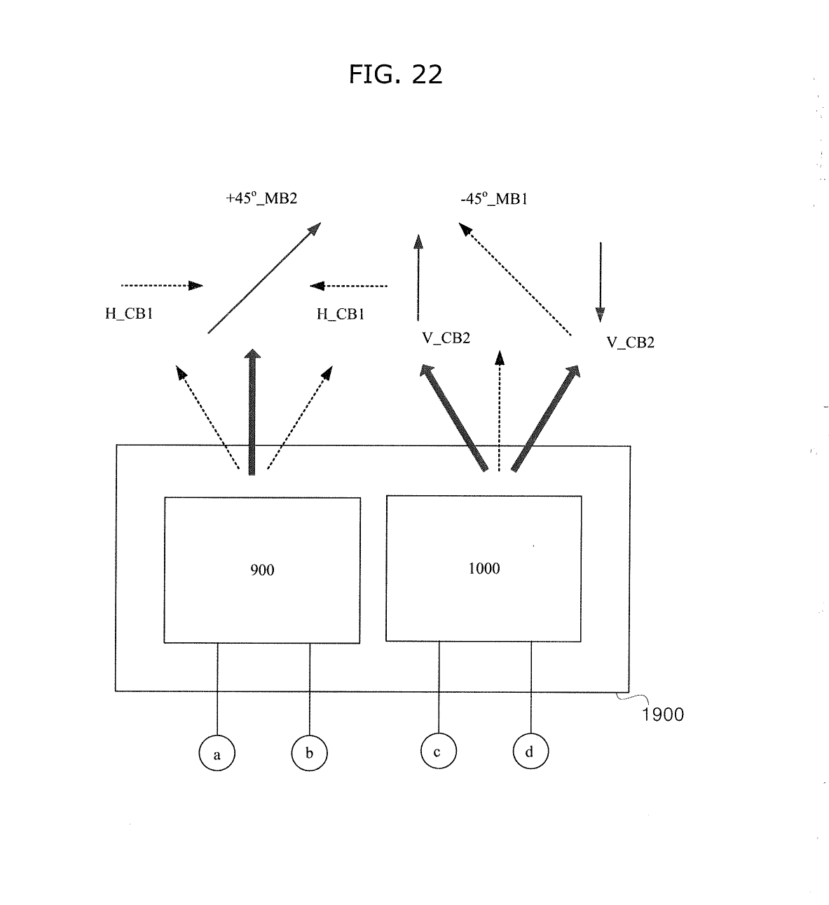

FIG. 22 is a conceptual diagram of a fourteenth antenna with the 4×4 MIMO antenna structure in the communication system in accordance with the embodiment of the present invention.

Referring to FIG. 22, the fourteenth antenna 1900 includes the fourth antenna 900 and the fifth antenna 1000. In addition, the fourteenth antenna 1900 includes input terminals a, b, c, and d.

The fourteenth antenna 1900 generates the horizontal polarization signal (first conical beam H_CB1) and the linear polarization signal of +45° (second main beam (+45°_MB2)) by the fourth antenna 900 structure. In addition, the fourteenth antenna 1900 generates the linear polarization signal of −45° (first main beam (−45°_MB1)) and the vertical polarization signal (second conical beam V_CB2) by the fifth antenna 1000 structure.

The four signals input through the input terminals a, b, c, and d from the fourteenth antenna 1900 have four independent radiation characteristics and are radiated to the free space. Therefore, the fourteenth antenna 1900 is the 4×4 MIMO antenna.

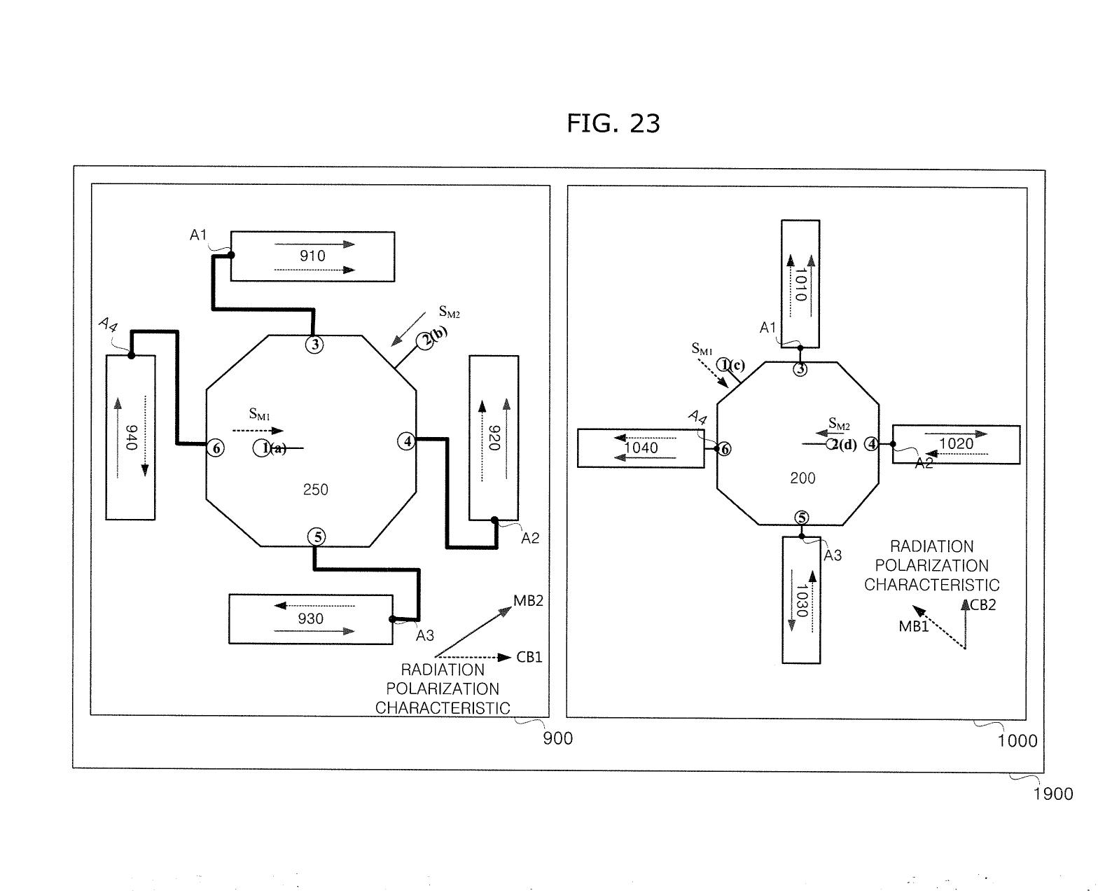

FIG. 23 is a diagram illustrating the fourteenth antenna structure of FIG. 22.

Referring to FIG. 23, the fourteenth antenna 1900 has a structure in which the fourth antenna 900 is connected with the fifth antenna 1000.

In this case, the description of the detailed structure of the fourteenth antenna 1900 refers to the descriptions of the fourth antenna 900 and the fifth antenna 1000, respectively.

The first input terminal a of the fourteenth antenna 1900 corresponds to the first input terminal 1 of the fourth antenna 900 and the second input terminal b thereof corresponds to the second input terminal 2 of the fourth antenna 900. As described above, the third input terminal c of the fourteenth antenna 1900 corresponds to the first input terminal 1 of the fifth antenna 1000 and a fourth input terminal d thereof corresponds to the second input terminal 2 of the fifth antenna 1000.

In this way, the horizontal polarization signal (first conical beam H_CB1) and the linear polarization signal of +45° (second main beam +45°_MB2) are generated by the fourth antenna 900 structure. Further, the linear polarization signal of −45° (first main beam (−45°_MB1)) and the vertical polarization signal (second conical beam V_CB2) are generated by the fifth antenna 1000 structure.

Meanwhile, in FIGS. 20 to 23, the linear polarization signal of +45° or the linear polarization signal of −45° shows the polarization signal deflected based on the main beam direction.

As described above, the 4×4 MIMO antennas in accordance with the embodiment of the present invention are described by way of example and may be implemented in various forms by the combination of 2×2 antennas.

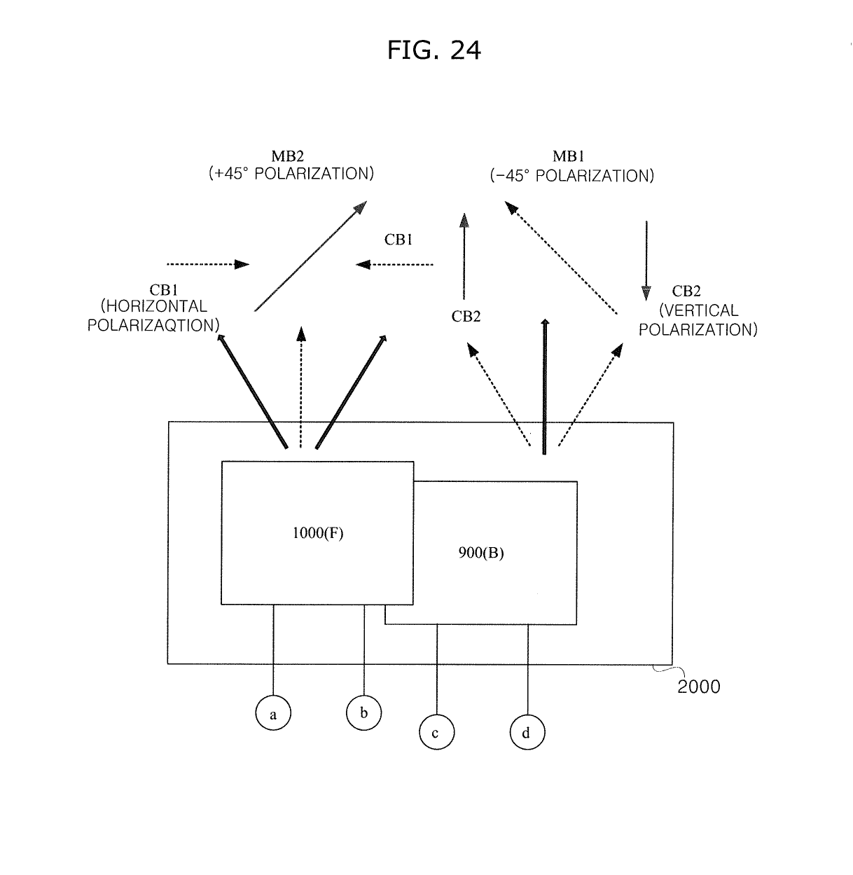

FIG. 24 is a conceptual diagram of the fifteenth antenna with the 4×4 MIMO antenna structure of the reduced size in accordance with the embodiment of the present invention.

Referring to FIG. 24, a fifteenth antenna 2000 includes a fourth antenna 900B and a fifth antenna 1000F. In addition, the fifteenth antenna 2000 includes the input terminals a, b, c, and d. Here, alphabet ‘F’ attached to antennas in the fifteenth antenna 2000 shows one disposed to the front of the antenna and alphabet ‘B’ shows one disposed to the rear of the antenna. Therefore, the fourth antenna 900B is disposed at the rear of the fifteenth antenna 200 and the fifth antenna 1000F is disposed at the front of the fifteenth antenna 2000.

The fifteenth antenna 1500 shares the array antenna elements between two antenna structures included therein so as to reduce the size of the fifteenth antenna 1500. For example, the array antenna elements may have a regular square form so as to be shared between two antenna elements.

Meanwhile, the fifteenth antenna 2000 generates the horizontal polarization signal (second conical beam H_CB1) and the linear polarization signal of +45° (second main beam (+45°_MB2)) by the fifth antenna 1000 structure. In addition, the fifteenth antenna 2000 generates the linear polarization signal of −45° (second main beam −45°_MB2) and the vertical polarization signal (second conical beam V_CB2) by the fourth antenna 900B structure.

The four signals input through the input terminals a, b, c, and d from the fifteenth antenna 2000 have four independent radiation characteristics and are radiated to the free space. Therefore, the fifteenth antenna 2000 is the 4×4 MIMO antenna.

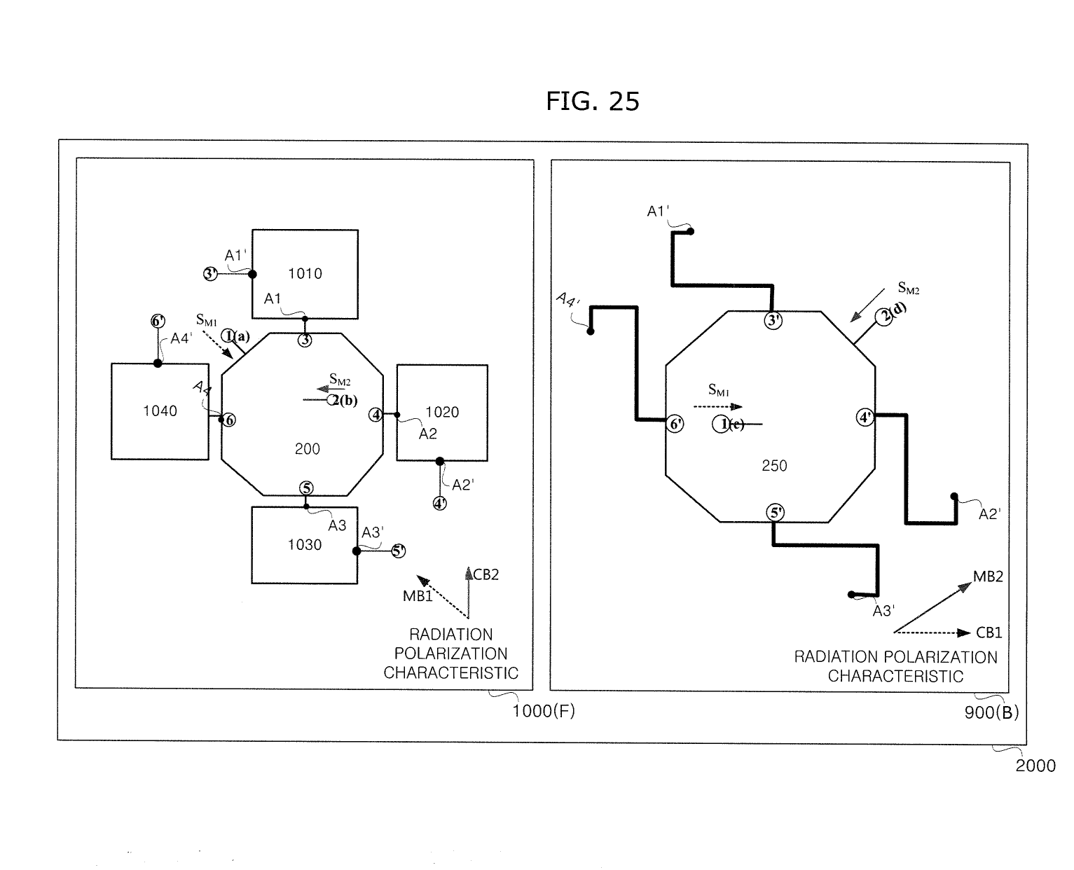

FIG. 25 is a diagram illustrating the fifteenth antenna structure illustrated in FIG. 24.

Referring to FIG. 25, the fifteenth antenna 2000 has a structure in which the fifth antenna 1000F is located at the front thereof and the fourth antenna 900B is located at the rear thereof.

In this case, the description of the detailed structure of the fourteenth antenna 2000 refers to the descriptions of the fourth antenna 900 and the fifth antenna 1000, respectively.

However, the fourth antenna 900B and the fifth antenna 1000F may share an antenna. Here, for convenience of explanation, the case in which the fourth antenna 900F may share the array antenna elements 1010, 1020, 1030, and 1040 of the fifth antenna 1000F with a regular square form is described by way of example, but may share the array antenna elements (herein, not illustrated) of the fourth antenna 900B with the fifth antenna 1000F.

Therefore, the first input terminal a of the fifteenth antenna 2000 corresponds to the first input terminal 1 of the fifth antenna 1000F and the second input terminal b thereof corresponds to the second input terminal 2 of the fifth antenna 1000. As described above, the third input terminal c of the fifteenth antenna 2000 corresponds to the first input terminal 1 of the fourth antenna 900B and the fourth input terminal d thereof corresponds to the second input terminal 2 of the fourth antenna 900B.

In this case, each of the output terminals 3′, 4′, 5′ and 6′ of the fourth antenna 900B is connected with antenna terminals A1′, A2′, A3′, and A4′ of the array antenna elements 1010, 1020, 1030, and 1040.

In this way, the horizontal polarization signal (second conical beam H_CB1) and the linear polarization signal of +45° (second main beam +45°_MB2) are generated by the fifth antenna 1000F structure. Further, the linear polarization signal of −45° (second main beam −45°_MB2) and the vertical polarization signal (second conical beam V_CB2) are generated by the fourth antenna 900B structure.

As described above, the fifteenth antenna 2000 in accordance with the embodiment of the present invention may radiate the two linear polarization signals of +45°/−45° in the main beam direction and may radiate the vertical/horizontal signals in the conical beam direction.

The fifteenth antenna 2000 disposes the antenna elements configured therein at the front/rear thereof while sharing the antenna and therefore, the area required for the antenna configuration may be reduced.

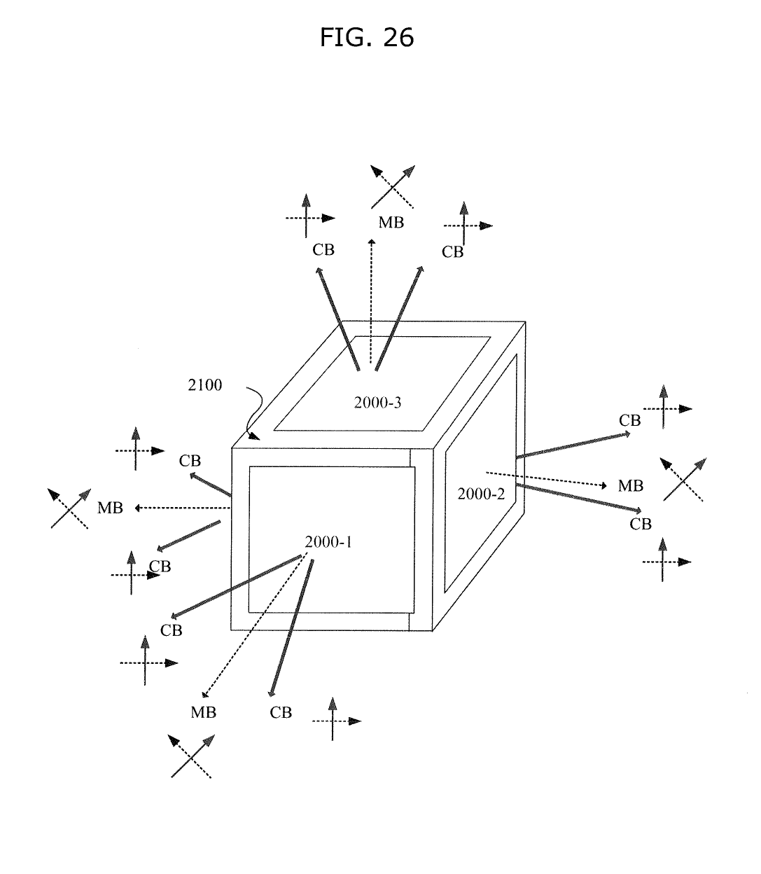

FIG. 26 is a diagram illustrating a sixteenth antenna with the extended number of channels using the fifteenth antennas in the communication system in accordance with the embodiment of the present invention.

Referring to FIG. 26, a sixteenth antenna 2100 is an antenna with a regular hexahedral shape and each surface of the hexahedron may be configured of fifteenth antennas 2000-1, 2000-2, 2000-3 (not illustrate), 2000-4 (not illustrated), 2000-5, and 2000-6 (not illustrated).

The sixteenth antenna 2100 has a structure in which six antenna modules combined with the antennas 900B and 1000F are located at each surface of the regular hexahedron.

The fifteenth antennas 2000-1, 2000-2, 2000-3 (not illustrated, 2000-4 (not illustrated), 2000-5, and 2000-6 (not illustrated) configuring the sixteenth antenna 2100 are arranged on each surface of the regular hexahedron and therefore, the number of channels may be extended to 24 channels. Therefore, the sixteenth antenna 2100 is a 24×24 MIMO antenna apparatus.

As described above, the antennas (for example, MIMO antennas) including the multi-function feed network in accordance with the embodiment of the present invention have the high isolation characteristic between the array antenna elements and may variably control the polarization and the beam pattern of the antenna according to the wireless environment or the system requirement.

Further, the antennas including the multi-function feed network in the embodiment of the present invention may extend the number of channels of the signals input and output through the combining therebetween or the rearrangement in various forms.

For convenience of explanation, the embodiment of the present invention as described above proposes the antenna structures including various multi-function feed networks, but the antenna with various functions can be implemented by the combination of the multi-function feed networks and the antennas or the rearrangement of the elements in addition to the antenna structures including the foregoing multi-function feed network.

Meanwhile, the embodiments is described in detail in the detailed description of the present invention, but may be variously modified without departing from the scope of the present invention. Accordingly, the scope of the present invention is not construed as being limited to the described embodiments but is defined by the appended claims as well as equivalents thereto.

In accordance with the exemplary embodiments of the present invention, it is possible to provide various beam pattern diversities and orthogonal polarization diversities at the time of transmitting a signal using the antenna including the multi-function feed network, by providing various multi-function feed networks in which the antenna elements with the disposition and arrangement of the input and output terminals of the feed network configured of the plurality of transmission lines in the communication system are arrayed and the antennas including the multi-function feed networks.

Meanwhile, the embodiments is described in detail in the detailed description of the present invention, but may be variously modified without departing from the scope of the present invention. Accordingly, the scope of the present invention is not construed as being limited to the described embodiments but is defined by the appended claims as well as equivalents thereto.

What is claimed is:

1. An antenna including a multi-function feed network in a communication system, comprising:
array antenna elements configured to transmit and receive signals; and
a feed network configured to divide and output a plurality of input signals to the array antenna elements,
wherein the feed network includes:
output nodes;
boundary transmission lines connecting between the output nodes;
cross transmission lines configured to be connected with a part of the boundary transmission lines and crossed in an area configured of the boundary transmission lines;
input terminals configured to be connected with one of nodes formed by the boundary transmission lines and nodes formed by the cross transmission lines and input signals; and
output terminals configured to be connected with each of the output nodes and output the input signals.

2. The antenna of claim 1, further comprising:
input transmission lines located between the input terminals and nodes connected with the input terminals; and
output transmission lines located between the output nodes and the output terminals.

3. The antenna of claim 2, wherein: when the input transmission lines and the output transmission lines have first characteristic impedance, the boundary transmission lines and the cross transmission lines have second characteristic impedance corresponding to impedance two times larger than the first characteristic impedance.

4. The antenna of claim 3, wherein: the boundary transmission lines and the cross transmission lines have an electrical length of 90°.

5. The antenna of claim 1, wherein: two boundary transmission lines are each located between the output terminals, and
the two cross transmission lines are each located between contacts of the boundary transmission lines located between the output terminal and are crossed in the area configured of the boundary transmission lines.

6. The antenna of claim 5, wherein: the input terminals are located at the contacts of the two boundary transmission lines located between the output terminals.

7. The antenna of claim 6, wherein: one of the input terminals is connected with one of the contacts of the two cross transmission lines located between the contacts of the boundary transmission lines.

8. The antenna of claim 7, wherein: the feed network further includes switch elements switching the input terminals so as to select one of the contact of the two boundary transmission lines and the contact of the two cross transmission lines.

9. The antenna of claim 8, wherein: the switch element is a single pole double throw (SPDT) switch.

10. The antenna of claim 1, wherein: the boundary transmission lines and the cross transmission lines each include capacitor elements, first inductor elements are each connected with the contacts of the boundary transmission lines connected with the output terminals, and second inductor elements are each connected with each contact between the boundary transmission lines and the cross transmission lines.

11. The antenna of claim 1, wherein: the boundary transmission lines and the cross transmission lines each include inductor elements, first capacitor elements are each connected with the contacts of the boundary transmission lines connected with the output terminals, and second capacitor elements are each connected with each contact between the boundary transmission lines and the cross transmission lines.

12. The antenna of claim 1, wherein: the array antenna elements include antenna terminals for connecting with the output nodes.

13. The antenna of claim 11, further comprising:
phase shifters configured to be located at at least a part between the antenna terminals and the output nodes and shift phases of signals output to the array antenna elements.

14. The antenna of claim 13, wherein: the phase shifters include at least one of a phase shifter shifting a phase by 90°, a phase shifter shifting a phase by 180°, and a phase shifter shifting a phase by 90°/180°.

15. The antenna of claim 12, wherein: when the array antenna elements are connected with the output terminals of the feed network, at least a part of the array antenna elements are located so as to face each other, and
the array antenna elements are arranged in one of a ring type enclosing the feed network and a cross type enclosing the array antenna elements based on the antenna terminals in an opposite direction of the feed network.

16. The antenna of claim 15, wherein the antenna array has a ring type and includes a first antenna generating a linear polarization signal in a direction of +45° and a horizontal polarization signal in a conical beam direction; and
the antenna array has a cross type and includes a first antenna generating a linear polarization signal in a direction of −45° as a main beam direction and a vertical polarization signal in a conical beam direction.

17. The antenna of claim 16, wherein: the first antenna and the second antenna are disposed at a front and a rear relative to each other so as to reduce an area and have the array antenna elements shared therebetween.

18. The antenna of claim 16, wherein: the array antenna elements have a regular square structure.

19. The antenna of claim 17, wherein: each surface of a regular hexahedral antenna is provided with six antenna modules configured of the first antenna and the second antenna.

20. A multi-function feed network in a communication system, comprising:
a plurality of output nodes;
boundary transmission lines connecting between the output nodes;
cross transmission lines configured to be connected with a part of the boundary transmission lines and crossed in an area configured of the boundary transmission lines;
input terminals configured to be connected with one of nodes formed by the boundary transmission lines and nodes formed by the crossing transmission lines and input signals; and
output terminals configured to be connected with each of the output nodes and divide and output the input signals.
